(19) United States
(12) Patent Application Publication
(10) Pub. No.: US 2007/0206495 A1
(43) Pub. Date: Sep. 6, 2007

(54) Transmission apparatus and communication control method

(75) Inventor: Yoshinobu Takagi, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/453,410

(22) Filed: Jun. 15, 2006

(30) Foreign Application Priority Data
Mar. 1, 2006 (JP) 2006-055457

(51) Int. Cl. H04J 3/14

(52) U.S. Cl. 370/228

(57) ABSTRACT

This invention is to carry out communication control according to required line quality. A transmission apparatus according to this invention includes: a line database that stores required line quality data for each first line connecting between the transmission apparatus and a router; a fault detector that detects a line fault in the first lines or a second line connecting between the transmission apparatus and another transmission apparatus; and a unit that identifies a line to be controlled from the first lines based on information of the line fault or the information of the line fault and the required line quality data, upon detection of the line fault by the fault detector. Accordingly, even if the line quality is degraded, the communication control can be carried out. Moreover, even if the required line quality varies for each router, the line to be controlled can be identified according to the required line quality.

### TECHNICAL FIELD OF THE INVENTION

The present invention relates to a path control technique in networks.

### BACKGROUND OF THE INVENTION

In recent years, a high-speed optical interface such as a GbE (Gigabit Ethernet™) is on its way to becoming a local area network (LAN) access method for the next-generation, in line with a demand for increasing the speed of LAN interfaces. Meanwhile, as for a wide area network (WAN) technique, a wave division multiplex (WDM) based large core network, basically using the techniques of the synchronous optical network and synchronous digital hierarchy (SONET/SDH), is being actively introduced, and large-capacity networks begin to be used in both LAN and WAN.

Accordingly, there is an effort underway to improve a throughput of the entire network with an access from a LAN system (for example, an internet protocol (IP) network) directly to a SONET/SDH apparatus (that is, a SONET/SDH network). In years to come, it is conceivable that connections between SONET/SDH or WDM and LAN increase, and a core network is particularly required to have a stable redundancy function.

For example, US 2003/0076857 discloses a technique in which, if a line fault (for example, disconnection) occurs on a line (hereinafter, referred to as “SONET/SDH line”) between transmission apparatuses in a network where an IP network and a SONET/SDH network are connected to each other, the transmission apparatus transmits identification information of the line fault to an IP router under the IP network, and the IP router, having received it, updates its own routing table to halt sending packets to the transmission apparatus, thereby preventing the transmission of useless packets.

In the aforementioned publication, however, there is no description of a case where a line fault occurs on a line (hereinafter, referred to as “Ethernet™ line”) between the transmission apparatus and the IP router. Therefore, if a line fault occurs on the Ethernet™ line, no change occurs in the routing table of the IP router under the control of the transmission apparatus on the opposite side even if the fault is recognized by the transmission apparatus connected to the IP network where the line fault occurred, and thus the transmission apparatus on the opposite side sends useless packets.

Furthermore, there is a case where bit errors occur, for example, due to a failure in an optical fiber, on the SONET/SDH line and the SONET/SDH line deteriorates in quality in some cases, instead of a complete disconnection. In such a case, a stable communication can be achieved by switching the line to a redundant line if the SONET/SDH network is provided with a redundant configuration. Unless the SONET/SDH network is provided with the redundant configuration, however, the line cannot be switched to another and therefore the packets including path information and/or control information are intermittently exchanged between the IP routers, and it may hinder quick updating of the routing tables of the IP routers or quick communication path changes. As stated above, the communication path does not switch to another, though the transmission apparatus detected the deterioration in quality of the line, and therefore an unstable communication is carried out. Incidentally, the minimum line quality required for the communication depends upon an IP router in general.

As stated above, when a SONET/SDH line deteriorates in quality, a communication path cannot switch to another and a stable communication cannot be achieved in some cases.

Moreover, when a line fault occurs on an Ethernet™ line in a network configuration in which an IP network and a SONET/SDH network are connected to each other, routers may transmit useless packets due to an inappropriate communication control.

### SUMMARY OF THE INVENTION

Therefore, an object of the present invention is to provide a technique for carrying out a communication control according to a required line quality when a SONET/SDH line deteriorates in quality.

Another object of the present invention is to provide a technique for making it possible to carry out an appropriate communication control when a line fault occurs on a network in which an IP network and a SONET/SDH network are connected to each other.

A transmission apparatus according to this invention includes: a line database that stores required line quality data for each first line connecting between the transmission apparatus and a router; a fault detector that detects a line fault on the first line or a second line connecting between the transmission apparatus and another transmission apparatus; and a control target identifying unit that identifies a line to be controlled from among the first lines based on information of the line fault or on the information of the line fault and the required line quality in response to the detection of the line fault by the fault detector.

This enables communication control even in the case where the line quality deteriorates. In addition, even if the required line quality depends upon a router, the line to be controlled can be identified according to the required line quality.

In addition, the transmission apparatus may further include: a generator that generates a record containing a destination address and identification information of an output destination port corresponding to the destination address, and registers the generated record into a routing table; and a unit that invalidates a record in which the identification information of a connection port connected to the identified line to be controlled is registered as the identification information of the output destination port in the routing table.

This enables a status control for each record (namely, for each connection port) by using the routing table, and thus enables a communication control for each connection port. For example, it is possible to control a router connecting up to a connection port, which is designated in the record registered as an invalid record in the routing table, to halt a packet transmission to such a connection port.

Furthermore, the transmission apparatus may further include: a recovery detector that detects a line recovery on the identified line to be controlled; and a unit that validates the record in which the identification information of the connection port connected to the line to be controlled, for which the line recovery is detected, is registered as the identification information of the output destination port in the routing table, in response to detection of the line recovery by the recovery detector. This enables communication control according to the line recovery.

Moreover, the aforementioned line database may further store identification data to identify whether the line connected to the router is the line to be controlled. Then, the transmission apparatus may further include: a unit that updates the identification data when there is a change of the line to be controlled; and a unit that outputs information concerning at least a changed portion of the line database to a second transmission apparatus when there is a change in the line database. Furthermore, the transmission apparatus may further include: a unit that updates the line database based on received information concerning the line database when the information concerning the line database is received from the second transmission apparatus. This provides synchronization of the line database between the transmission apparatuses, whereby an appropriate path control is achieved in the network including the transmission apparatuses.

Moreover, the transmission apparatus may further include: a unit that outputs data of an added or changed record to the second transmission apparatus when there is an addition or change of the record in the aforementioned routing table. Furthermore, the transmission apparatus may further include: a unit that updates the routing table based on the received data concerning a record when the data concerning the record in the routing table is received from the second transmission apparatus. This provides synchronization of the routing table between the transmission apparatuses, whereby an appropriate path control is achieved in the network including the transmission apparatuses. In addition, when a line fault occurs between the other transmission apparatus and a router under the control of the other transmission apparatus, the transmission apparatus can determine that it cannot transfer packets to the router by achieving synchronization with the routing table of the other transmission apparatus. Therefore, it can discard the packets without transferring them to the other transmission apparatus.

Incidentally, this transmission apparatus may be configured by a processor and a program for causing the processor to execute the aforementioned processing. The program is stored into a storage medium or a storage device such as, for example, a flexible disk, a CD-ROM, a magneto-optical disk, a semiconductor memory, or a hard disk. In addition, the program may be distributed as digital signals over a network in some cases. Data under processing is temporarily stored in the storage device such as a computer memory.

### BRIEF DESCRIPTION OF THE DRAWINGS

FIG. 1 is a diagram to explain an outline of a network according to an embodiment of this invention;

FIG. 2 is a functional block diagram of a SONET/SDH apparatus according to the embodiment of this invention;

FIG. 3 is a diagram showing an example of a network configuration according to the embodiment of this invention;

FIG. 4 is a diagram showing a processing flow of a table generation processing;

FIG. 5A and FIG. 5B are diagrams showing examples of line state tables;

FIG. 6 is a diagram showing an example of a SONET/SDH frame format;

FIG. 7 is a diagram showing an example of a format of an F2 byte;

FIG. 8 is a diagram showing a setting example of the F2 byte;

FIG. 9 is a diagram showing an example of a format of a payload;

FIG. 10 is a diagram showing the definition of values set to the payload;

FIG. 11 is a diagram showing an example of the payload to which the line state table was set;

FIG. 12 is a diagram showing an example of the line state table;

FIG. 13A to FIG. 13C are diagrams showing examples of routing tables in routers;

FIG. 14A to FIG. 14C are diagrams showing examples of routing tables in routers;

FIG. 15A and FIG. 15B are diagrams showing examples of routing tables in the SONET/SDH apparatus;

FIG. 16 is a diagram showing a setting example of the F2 byte;

FIG. 17 is a diagram showing an example of a format of a payload;

FIG. 18 is a diagram showing an example of the routing table in the SONET/SDH apparatus;

FIG. 19 is a diagram showing a processing flow according to the embodiment of this invention;

FIG. 20 is a diagram showing a processing flow according to a line state control processing;

FIG. 21 is a diagram showing an example of the line state table;

FIG. 22 is a diagram showing an example of a payload to which the line state table is set;

FIG. 23 is a diagram showing a processing flow of a routing control processing;

FIG. 24 is a diagram showing an example of the routing table in the SONET/SDH apparatus;

FIG. 25 is a diagram showing a setting example of the F2 byte;

FIG. 26 is a diagram showing an example of a format of a payload;

FIG. 27 is a diagram showing an example of a payload to which an IP address and an output destination are set;

FIG. 28 is a diagram showing a processing flow of a routing table update processing;

FIG. 29 is a diagram showing a processing flow according to the embodiment of this invention;

FIG. 30 is a diagram showing an example of the payload to which the line state table is set;

FIG. 31 is a diagram showing a setting example of the F2 byte;

FIG. 32 is a diagram showing an example of a format of a payload;

FIG. 33 is a diagram showing a processing flow according to the embodiment of this invention;

FIG. 34 is a diagram showing a processing flow of the line state control processing;

FIG. 35 is a diagram showing an example of the line state table;

FIG. 36 is a diagram showing an example of the payload to which the line state table is set:

FIG. 37 is a diagram showing an example of the routing table in the SONET/SDH apparatus;

FIG. 38 is a diagram showing an example of the payload to which the IP address and the output destination are set;

FIG. 39 is a diagram showing a processing flow according to the embodiment of this invention;

FIG. 40 is a diagram showing an example of a network configuration according to this embodiment of this invention; and

FIG. 41 is a diagram showing an example of a network configuration according to this embodiment of this invention.

### DETAILED DESCRIPTION OF THE PREFERRED EMBODIMENTS

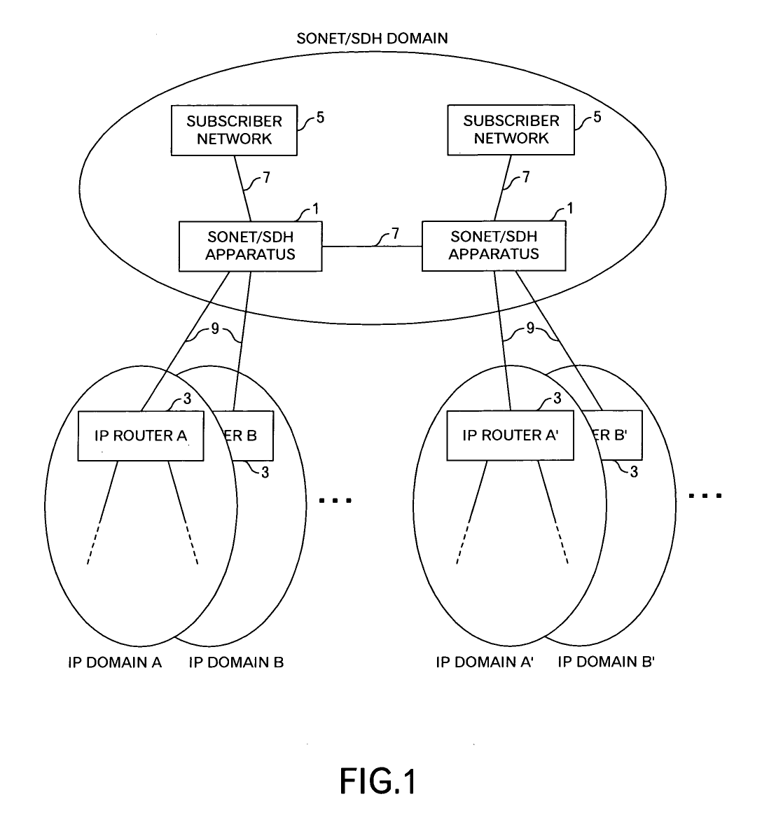

FIG. 1 shows a network schematic diagram according to an embodiment of the present invention. In FIG. 1, an optical fiber 7 connects SONET/SDH apparatuses 1 to each other and connects the SONET/SDH apparatus 1 to a subscriber network 5. A high-speed optical interface 9 (for example, GbE) connects the SONET/SDH apparatus 1 to an IP router 3. Furthermore, the SONET/SDH apparatuses 1 and the subscriber networks 5 form a SONET/SDH domain, and the IP router 3 and network equipments under the control thereof form an IP domain. Plural IP routers 3 (for example, an IP router A, IP router B, and the like) are connected to the SONET/SDH apparatus 1, and plural IP domains (for example, an IP domain A, IP domain B, and the like) are connected to the SONET/SDH domain.

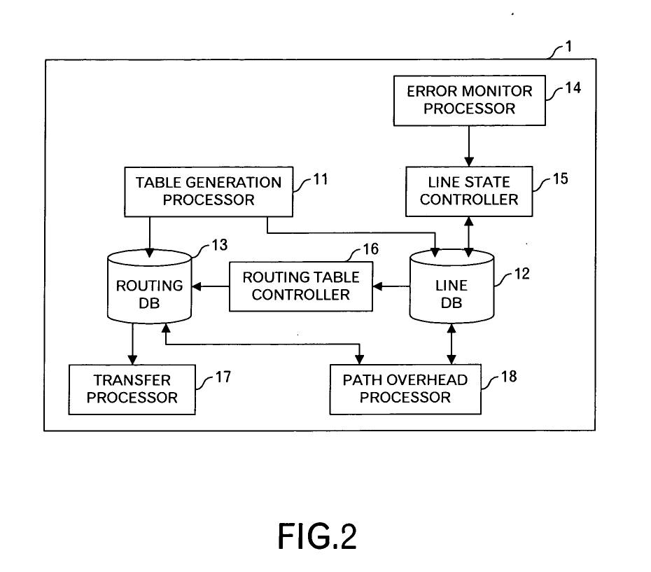

FIG. 2 shows an example of a functional block diagram of the SONET/SDH apparatus 1 shown in FIG. 1. The SONET/SDH apparatus 1 includes a table generation processor 11 that generates a line state table and a routing table at the activation time, a line DB 12 that stores the line state table generated by the table generation processor 11, a routing DB 13 that stores the routing table generated by the table generation processor 11, an error monitor processor 14 that monitors an error on a SONET/SDH line or an Ethernet™ line, a line state controller 15 that carries out a processing to identify a line to be controlled based on error information sent from the error monitor processor 14 and the line state table stored in the line DB 12 and the like, a routing table controller 16 that updates the routing table based on the line state table stored in the line DB 12, a transfer processor 17 that judges whether packets should be transferred, based on the routing table stored in the routing DB 13, and a path overhead processor 18 that exchanges information with the other SONET/SDH apparatus 1 by using a path overhead.

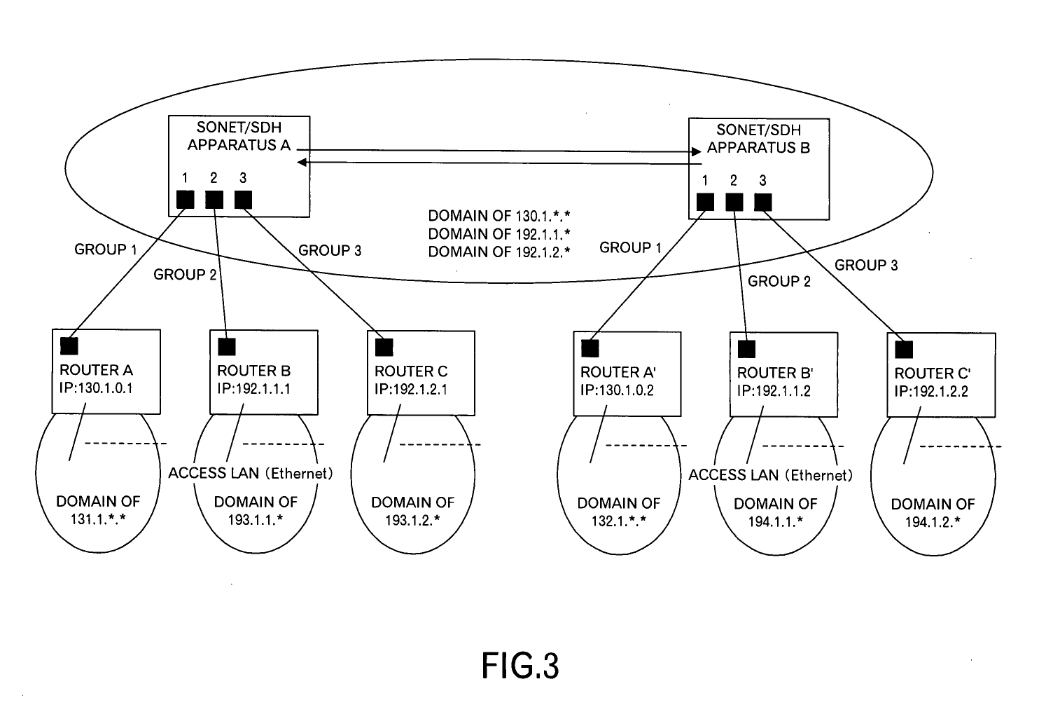

Next, a basic processing of the SONET/SDH apparatus 1 will be described with reference to FIGS. 3 to 18. Incidentally, a specific configuration of a network as shown in FIG. 3 is assumed in the following description. In FIG. 3, a port 1, a port 2, and a port 3 of a SONET/SDH apparatus A are connected to a router A, a router B, and a router C, respectively, and a port 1, a port 2, and a port 3 of a SONET/SDH apparatus B are connected to a router A′, a router B′, and a router C′, respectively. Incidentally, the SONET/SDH apparatuses A and B have the same functions as the SONET/SDH apparatuses 1, though they are denoted by A and B to simplify the description. In addition, the respective routers have the functions of general routers. Moreover, the router A and the router A′ constitute a group 1, the router B and the router B′ constitute a group 2, and the router C and the router C′ constitute a group 3. The IP address of the router A, the IP address of the router B, the IP address of the router C, the IP address of the router A′, the IP address of the router B′, and the IP address of the router C′ are assumed “130.1.0.1”, “192.1.1.1”, “192.1.2.1”, “130.1.0.2”, “192.1.1.2”, and “192.1.2.2”, respectively. Furthermore, each router is connected to an access LAN: the router A, the router B, the router C, the router A′, the router B′, and the router C′ are connected to “131.1.*.*” domain, “193.1.1.*” domain, “193.1.2.*” domain, “132.1.*.*” domain, “194.1.1.*” domain, and “194.1.2.*” domain, respectively.

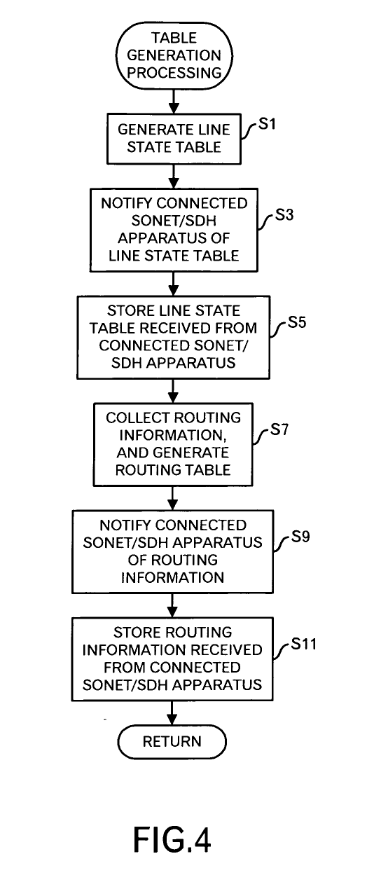

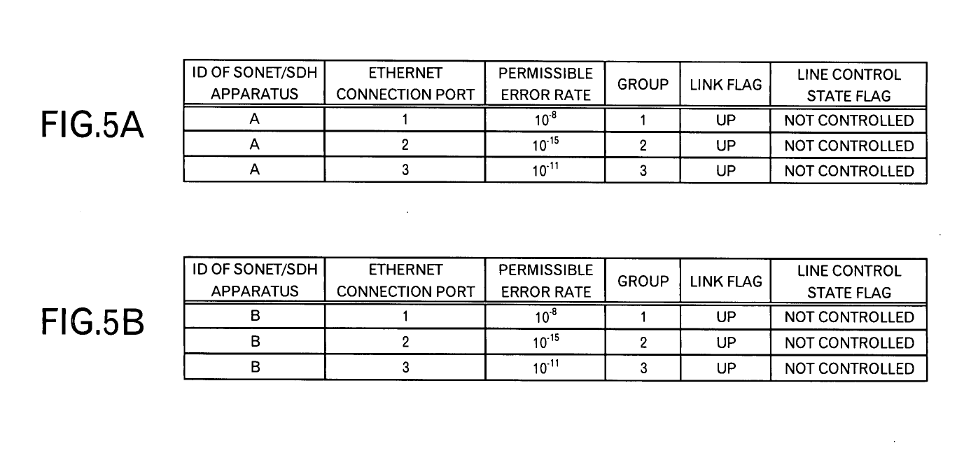

Next, a table generation processing at the initial setting of the SONET/SDH apparatus 1 will be described with reference to FIG. 4. First, the table generation processor 11 generates a line state table (step S1). FIGS. 5A and 5B show examples of the line state table. FIG. 5A shows the line state table in the SONET/SDH apparatus A, and FIG. 5B shows the line state table in the SONET/SDH apparatus B.

The tables in FIG. 5A and FIG. 5B each include a column of an ID of a SONET/SDH apparatus, a column of an Ethernet™ connection port, a column of a permissible error rate, a column of a group, a column of a link flag representing whether the link is up or down, and a line control state flag. The column of the ID of the SONET/SDH apparatus stores identification information of the SONET/SDH apparatus. For example, A for the SONET/SDH apparatus A or B for the SONET/SDH apparatus B is stored in this column. The column of the Ethernet™ connection port stores a port number. The column of the permissible error rate stores data indicating a tolerable range of the error rate at the port. The permissible error rate is used to judge whether or not the line concerned should be controlled when the line quality deteriorates. The column of the group stores the group number of each port. The link flag indicates the state of the current link: “UP” if the link is connected or “DOWN” if the link is disconnected due to a line fault or the like. The line control state flag indicates whether or not the line connected to the port is a line to be controlled: “NOT CONTROLLED” unless the line is to be controlled or “CONTROLLED” if the line is to be controlled.

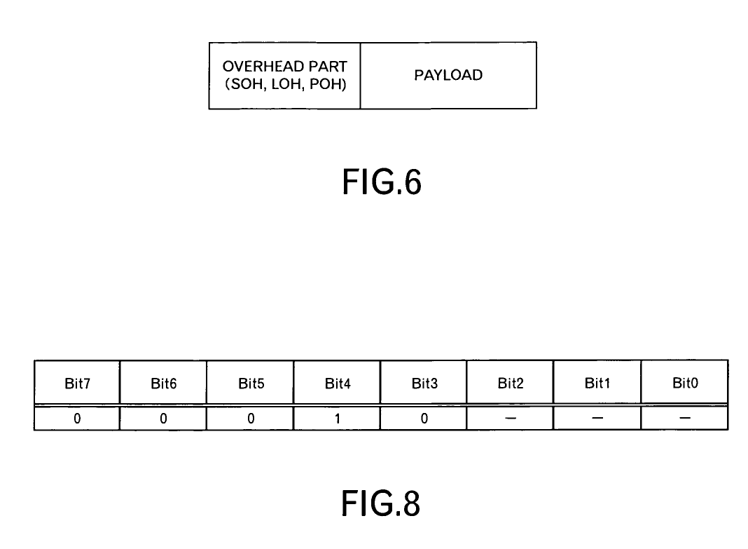

Thereafter, the path overhead processor 18 notifies the other SONET/SDH apparatus 1 of the generated line state table (step S3). Therefore, the SONET/SDH apparatus A and the SONET/SDH apparatus B notify each other of the line state table to achieve synchronization of the line state table. In this embodiment, as notification means, an unused region in the SONET/SDH frame is utilized, which is used for a normal data transmission between the SONET/SDH apparatuses 1. FIG. 6 shows an example of a SONET/SDH frame format. In the example shown in FIG. 6, the format is roughly divided into an overhead part and a payload. The overhead part includes a section overhead (SOH), a line overhead (LOH), a path overhead (POH), and the like and is used for frame synchronization and for monitoring data transmission quality. The payload includes packets received from the router and the like. Incidentally, the SONET/SDH frame conforms to the International Telecommunication Union (ITU) Recommendation. Therefore, its detailed description is omitted here.

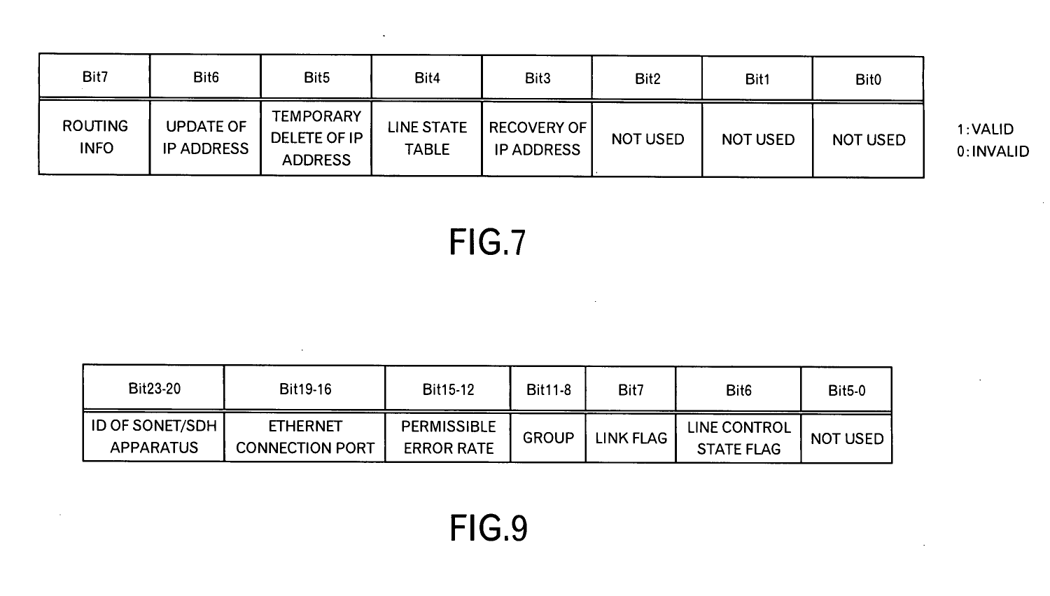

In this embodiment, the F2 byte, which is an unused region in the POH, and the payload are used. For example, the bits of the F2 byte are previously defined as shown in FIG. 7. In the example shown in FIG. 7, bit 7, bit 6, bit 5, bit 4 and bit 3 are defined as routing information, update of IP address, temporary delete of IP address, a line state table, and recovery of IP address, respectively, and bits 2 to 0 are unused. They indicate what information is notified in the payload of the SONET/SDH frame and the information to be notified is set in the payload. Each bit of the F2 byte is validated if it is set to 1 and invalidated if it is set to 0.

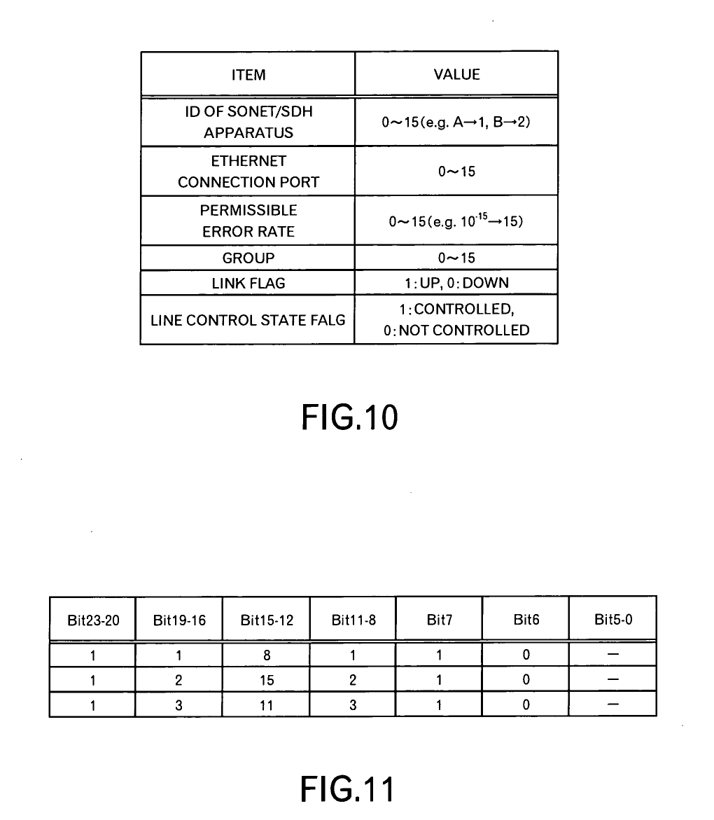

Therefore, the F2 byte is set as shown in FIG. 8 in order to notify the line state table. The bits 2 to 0 may be arbitrarily set, because they are unused. In FIG. 8, the bit 4 is valid, which indicates that the payload includes a line state table. In addition, FIG. 9 shows an example of a payload format when the line state table is set. In the example shown in FIG. 9, bits 23 to 20, bits 19 to 16, bits 15 to 12, bits 11 to 8, bit 7, and bit 6 are used to set the ID of the SONET/SDH apparatus, the Ethernet™ connection port, the permissible error rate, the group, the link flag, and the line control state flag, respectively, and bits 5 to 0 are unused. The values set at the bits in the payload format shown in FIG. 9 are as shown in FIG. 10. For example, in the case of the SONET/SDH apparatus A, “1” is used for the ID of the SONET/SDH apparatus A, and in the case of the SONET/SDH apparatus B, “2” is used for the ID of the SONET/SDH apparatus. In addition, for the permissible error rate, “15”, which is an absolute value of the exponent of 10⁻¹⁵, is set. FIG. 11 shows the payload containing the line state table of the SONET/SDH apparatus A shown in FIG. 5A. Incidentally, some other unused region may be used instead of the F2 byte. The path overhead processor 18 of the SONET/SDH apparatus A generates the F2 byte shown in FIG. 8 and the payload shown in FIG. 11, and notifies the SONET/SDH apparatus B of them.

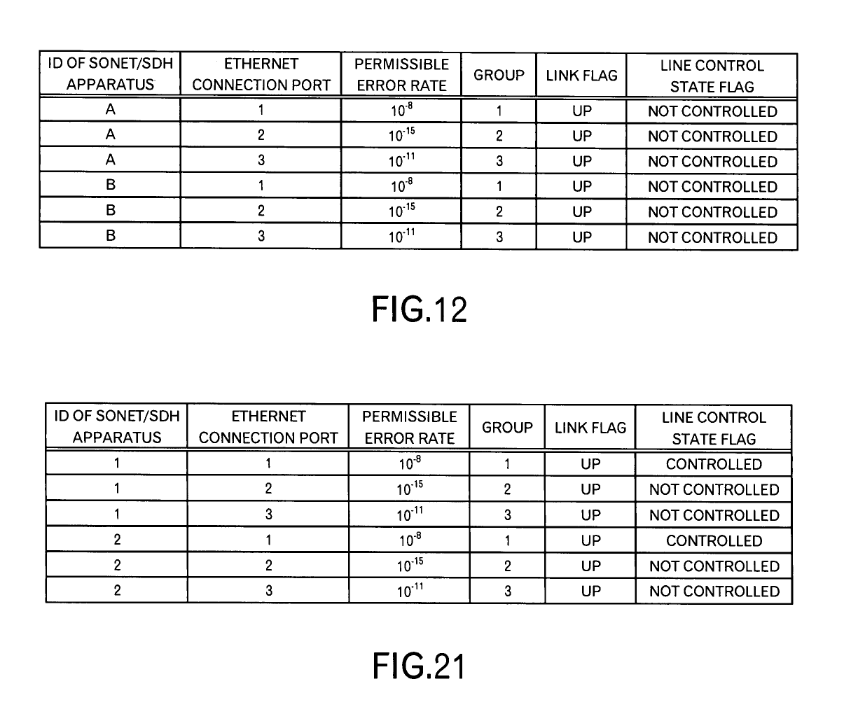

A path overhead processor 18 of the SONET/SDH apparatus B analyzes the F2 byte of the F2 byte to determine what information the payload includes. When it includes a line state table, the path overhead processor 18 of the SONET/SDH apparatus B stores the received information on the line state table into its own line state table (step S5). The line state table in the SONET/SDH apparatus B is updated as shown in FIG. 12. The line state table in FIG. 12 is a combination of the line state table of the SONET/SDH apparatus A shown in FIG. 5A and the line state table of the SONET/SDH apparatus B shown in FIG. 5B. Incidentally, also in the SONET/SDH apparatus A, the information on the line state table, which was received from the SONET/SDH apparatus B, is stored into its own line state table and consequently the line state table obtains the same content as in FIG. 12. Accordingly, synchronization of the line state table has been achieved between the SONET/SDH apparatus A and the SONET/SDH apparatus B.

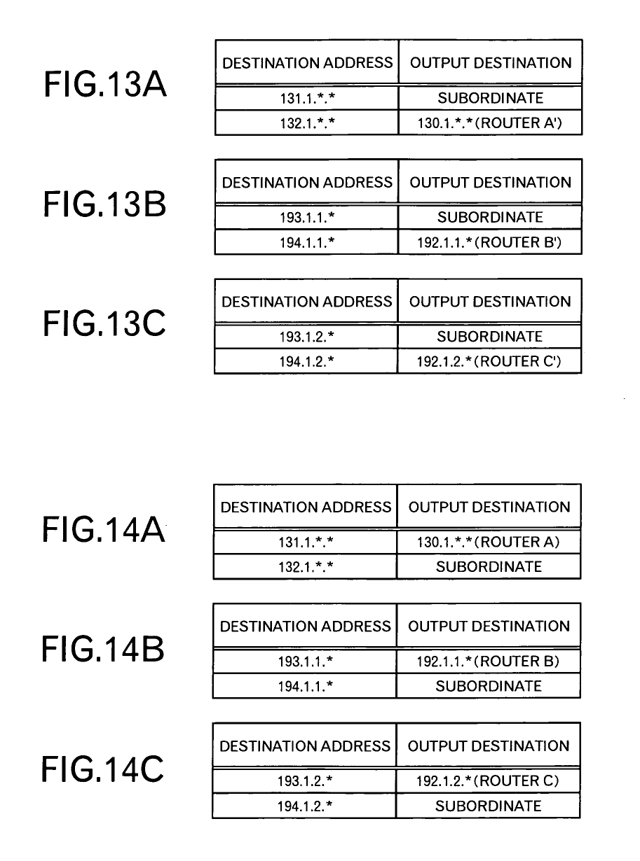

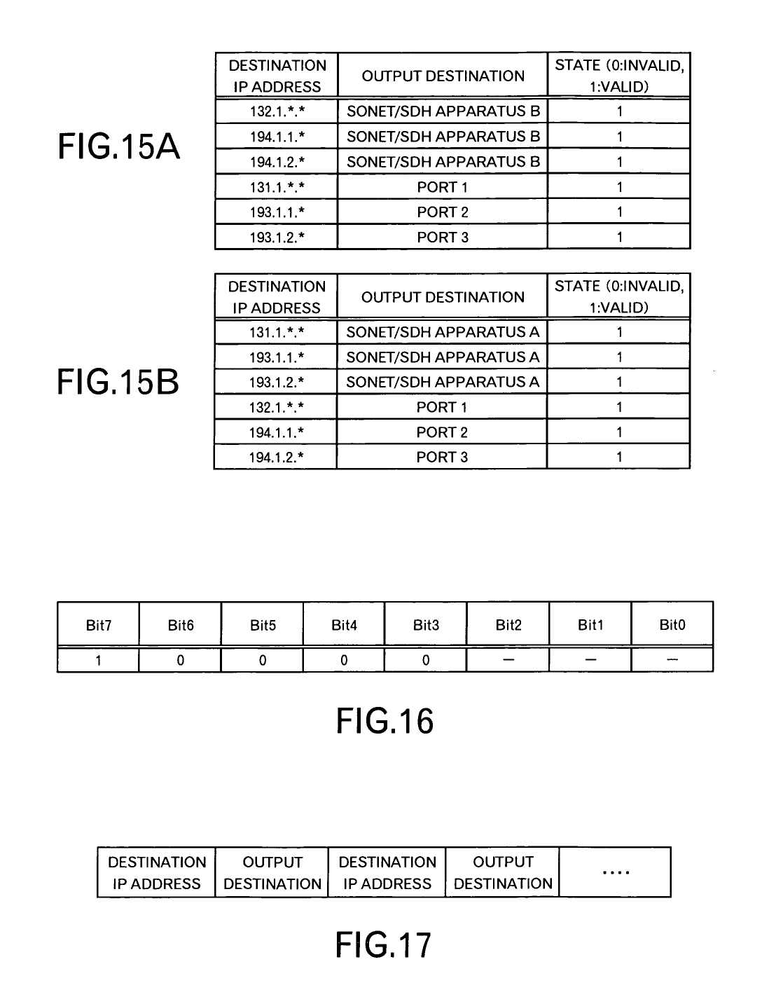

Subsequently, the table generation processor 11 collects routing information and generates a routing table (step S7). The routing tables of the routers in this embodiment are shown in FIGS. 13A to 13C and FIGS. 14A to 14C. FIG. 13A, FIG. 13B, FIG. 13C, FIG. 14A, FIG. 14B, and FIG. 14C show routing tables of the router A, the router B, the router C, the router A′, the router B′, and the router C′, respectively. The contents of the routing tables are based on the network configuration shown in FIG. 3. The routers exchange routing information on these routing tables by using a routing protocol (for example, the Open Shortest Path First (OSPF), Routing Information Protocol (RIP), or Border Gateway Protocol (BGP)). The table generation processor 11 collects the routing information exchanged by the routing protocol and generates the routing table. FIGS. 15A and 15B show examples of the routing tables: FIG. 15A shows a routing table in the SONET/SDH apparatus A and FIG. 15B shows a routing table in the SONET/SDH apparatus B. In the examples of FIGS. 15A and 15B, the routing table contains a column of a destination IP address, a column of an output destination, and a column of a state. Incidentally, the column of the output destination does not contain an IP address, but contains an Ethernet™ connection port connected to the output destination router or an ID of the SONET/SDH apparatus connected to the SONET/SDH apparatus 1 of the output destination.

Thereafter, the path overhead processor 18 notifies the other SONET/SDH apparatus 1 of the generated routing table (step S9). The notification means is basically the same as in the notification of the line state table. Because the bit 7 is defined as the routing information in the F2 byte definition shown in FIG. 7, the F2 byte is generated with the bit 7 set to 1 as shown in FIG. 16. Furthermore, FIG. 17 shows an example of the format of a payload in a case where a routing table is set. The combinations of a destination IP address and an output destination are set by the number of records. The SONET/SDH apparatus A notifies the SONET/SDH apparatus B of the routing table shown in FIG. 15A.

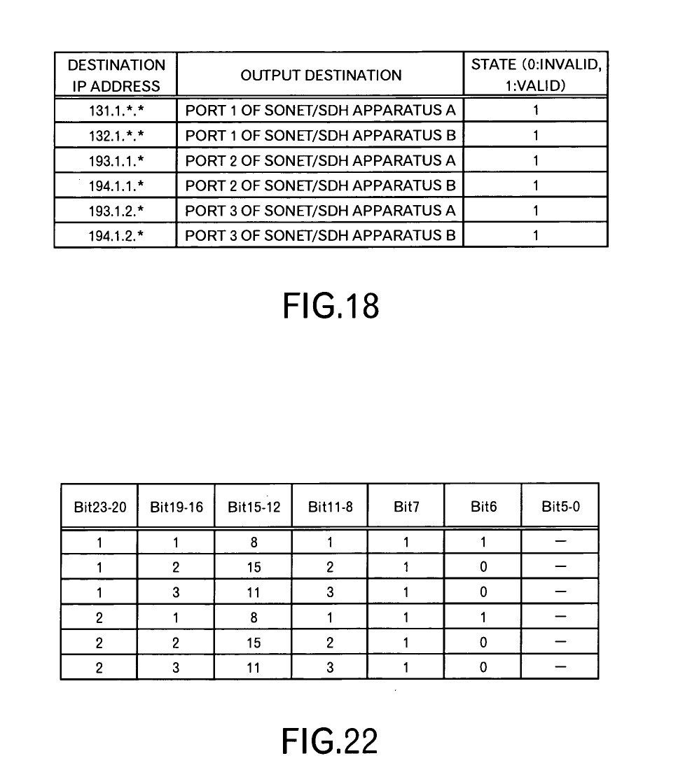

The path overhead processor 18 of the SONET/SDH apparatus B analyzes the F2 byte of the POH, and determines what information is included in the payload. When the routing table is included, the path overhead processor 18 of the SONET/SDH apparatus B stores the received information on the routing table into its own routing table (step S11). The routing table in the SONET/SDH apparatus B is updated as shown in FIG. 18. The routing table in FIG. 18 is a combination of the routing table of the SONET/SDH apparatus A shown in FIG. 15A and the routing table of the SONET/SDH apparatus B shown in FIG. 15B. Consequently, the output destination corresponding to the destination IP address “131.1.*.*” becomes the port 1 of the SONET/SDH apparatus A in FIG. 18, though it has been the SONET/SDH apparatus A in FIG. 15B. Therefore, the port can also be recognized in the routing table. Incidentally, the SONET/SDH apparatus A receives the routing table from the SONET/SDH apparatus B, and consequently the routing table obtains the same content as in FIG. 18. Accordingly, synchronization of the routing table has also been achieved between the SONET/SDH apparatus A and the SONET/SDH apparatus B.

Incidentally, in the case where a change occurs in the network configuration and thus a change occurs in a line state table or a routing table, the SONET/SDH apparatus A exchange information with the SONET/SDH apparatus B in the manner as described above to constantly maintain synchronization therebetween in the line state table and the routing table.

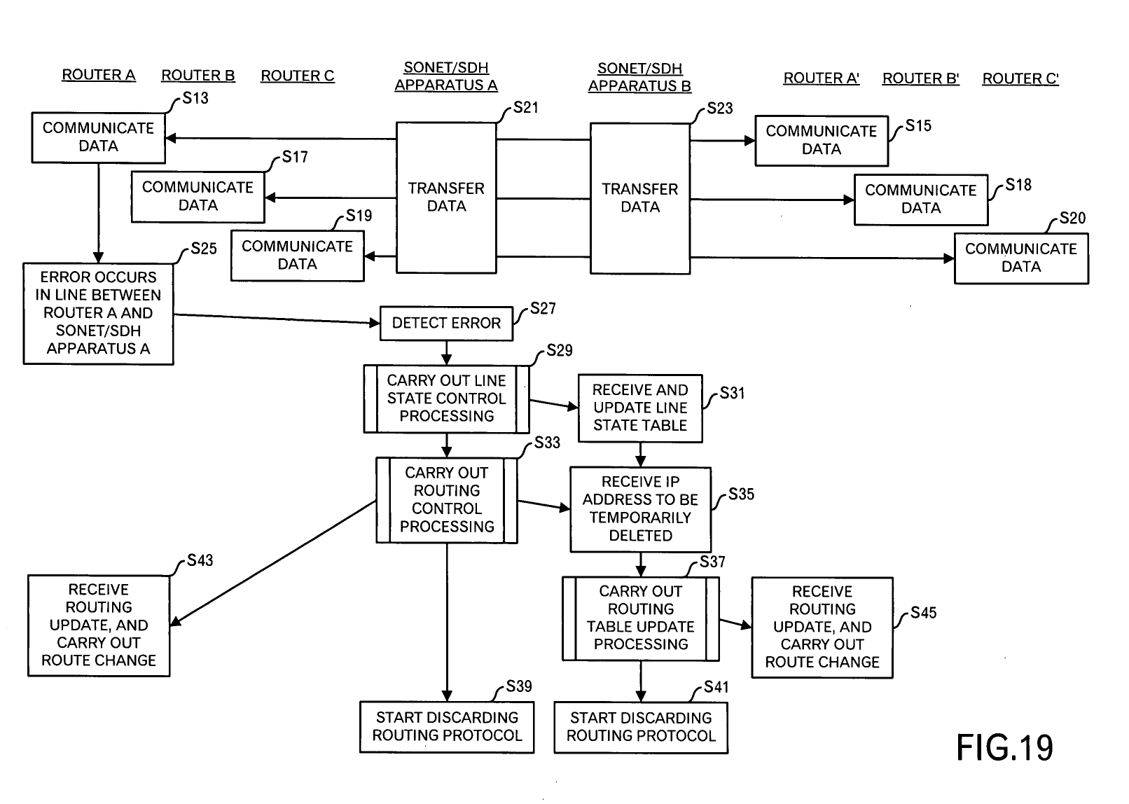

The following describes a processing for a case where a line fault occurs between the router A and the SONET/SDH apparatus A in the network configuration shown in FIG. 3 with reference to FIGS. 19 to 28. FIG. 19 shows a processing flow in the entire network. First, data communications are being conducted via the SONET/SDH apparatus A and the SONET/SDH apparatus B between the router A and the router A′ (steps S13 and S15). Similarly, data communications are being conducted between the router B and the router B′ and between the router C and the router C′ (steps S17 to S20). During the data communications, the transfer processors 17 of the SONET/SDH apparatus A and the SONET/SDH apparatus B transfer data to the respective routers (steps S21 to S23). The data transfer is a conventional technique and therefore the description is omitted here.

In this embodiment, it is assumed that line quality deterioration of a 10⁻⁷-level error rate occurred between the router A and the SONET/SDH apparatus A (step S25). The error monitor processor 14 of the SONET/SDH apparatus A detects an error satisfying a predetermined condition (step S27). The error monitor processor 14 notifies the line state controller 15 of error information. The error information contains, for example, link information indicating a link state, an error rate, and an error port number where a line fault is detected. Upon receiving the error information, the line state controller 15 carries out a line state control processing (step S29).

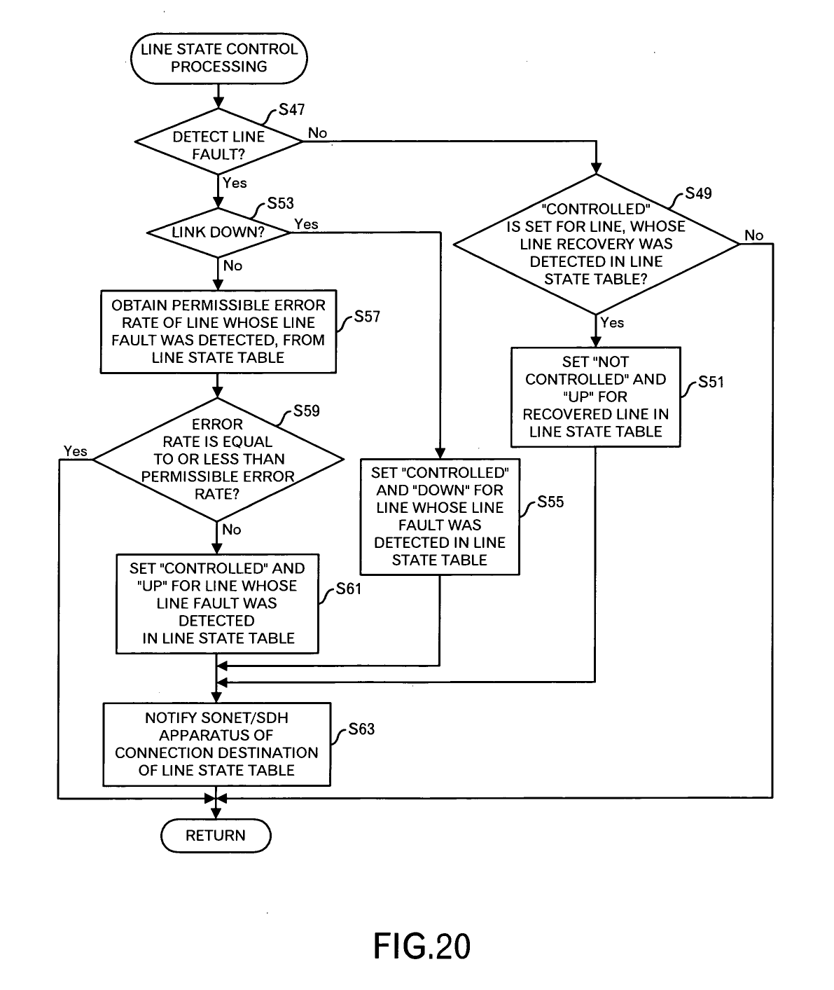

The line state control processing will be described with reference to FIG. 20. First, the line state controller 15 judges whether or not a line fault is detected (step S47). It judges whether a line fault or a line recovery is detected, because the line state control processing is triggered by detecting the line fault or line recovery. Incidentally, while a processing carried out when the line recovery is detected will be described later, it is assumed that recovery information including a recovery port number of the port where the line recovery is detected or the like is received in this case. When the line recovery is detected (step S47: No route) instead of the line fault, it judges whether or not the line control state flag of the line whose line recovery was detected (namely, the line for which a recovery port number is stored an the Ethernet™ connection port (No.) in the line state table) is set to “CONTROLLED” in the line state table (step S49). When the line control state flag of the line where the line recovery is detected is set to “CONTROLLED” (step S49: YES route), it sets the line control state flag of the recovered line to “NOT CONTROLLED” and the link flag of the recovered line to “UP” in the line state table (step S51). When the link flag of the recovered line has already been set to “UP,” the setting is directly used. On the other hand, when the line control state flag of the line where the line recovery is detected is set to “NOT CONTROLLED,” it terminates the line state control processing and the processing returns to the original processing (step S49: NO route).

On the other hand, when the line fault is detected (step S47: YES route), the line state controller 15 judges whether or not the link is disconnected based on the link information (step S53). When the link is disconnected (step S53: YES route), the line state controller 15 sets the line control state flag of the line where the line fault is detected (namely, the line for which the fault port number is stored as the Ethernet™ connection port (No.) in the line state table) to “CONTROLLED” and the link flag to “DOWN” (step S55). On the other hand, when line quality deterioration occurs instead of the link disconnection (step S53: NO route), the line state controller 15 obtains a permissible error rate of the line where the line fault was detected from the line state table (step S57). Then, the line state controller 15 compares the error rate in the error information with the permissible error rate (step S59). When the error rate is equal to or less than the permissible error rate, it is determined that the line need not be controlled, the line state control processing is terminated, and the processing returns to the original processing (step S59: YES route). On the other hand, when the error rate exceeds the permissible error rate (step S59: NO route), the line state controller 15 sets the line control state flag to “CONTROLLED” and the link flag to “UP” for the pertinent line in the line state table (step S61). Then, when there is any change in the line state table, the line state controller 15 notifies the connected SONET/SDH apparatus 1 of the line state table (step S63), and the processing returns to the original processing. Incidentally, the line state controller 15 of the SONET/SDH apparatus 1 may notify only a changed portion in the line state table in the processing of the step S63.

In this embodiment, although the permissible error rate of the port 1 in the SONET/SDH apparatus A is 10⁻⁸ in the line state table shown in FIG. 12, an error of a 10⁻⁷-level error rate occurs and it exceeds the permissible range. Therefore, the line connected to the port 1 is determined to be a line to be controlled, and the line control state flag of the port 1 in the line state table is set to “CONTROLLED” as shown in FIG. 21. In this case, the port 1 of the SONET/SDH apparatus A belongs to the group 1, and therefore the line control state flag of the port 1 belonging to the group 1 at the SONET/SDH apparatus B side is also set to “CONTROLLED.” Thereafter, the path overhead processor 18 of the SONET/SDH apparatus A notifies the SONET/SDH apparatus B of the line state table shown in FIG. 21. At this moment, the F2 byte shown in FIG. 8 and the payload shown in FIG. 22 are set in the SONET/SDH frame.

Returning to the description of FIG. 19, the path overhead processor 18 of the SONET/SDH apparatus B receives the line state table, and updates its own line state table based on the received information on the line state table (step S31). Specifically, the line state table in the SONET/SDH apparatus B also becomes the content as shown in FIG. 21.

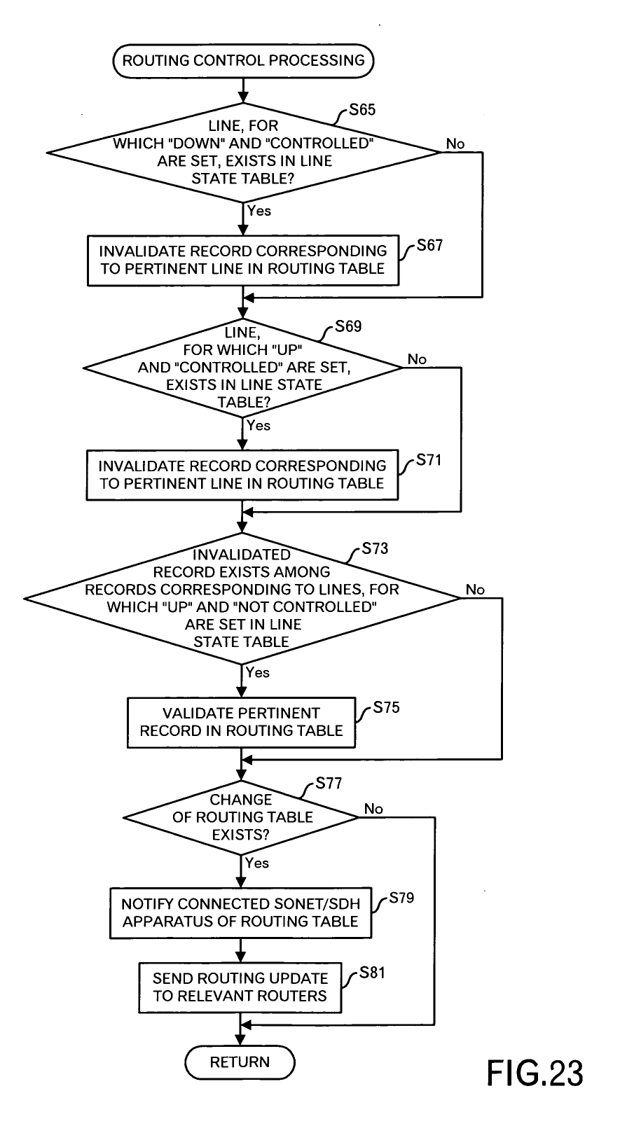

Subsequently, the routing table controller 16 of the SONET/SDH apparatus A carries out a routing control processing (step S33). The routing control processing will be described with reference to FIG. 23. First, the routing table controller 16 judges whether or not there is a line whose link flag is set to “DOWN” and whose line control state flag is set to “CONTROLLED” in the line state table (step S65). Unless there is such a line (step S65: NO route), the processing progresses to a processing of step S69 described later. On the other hand, if there is such a line (step S65: YES route), the routing table controller 16 invalidates the record corresponding to the line in the routing table (step S67). Thereafter, the routing table controller 16 judges whether there is a line whose link flag is set to “UP” and whose line control state flag is set to “CONTROLLED” in the line state table (step S69). Unless there is such a line (step S69: NO route), the processing progresses to a processing of step S73 described later. On the other hand, if there is such a line (step S69: YES route), the routing table controller 16 invalidates the record corresponding to the line in the routing table (step S71). Next, the routing table controller 16 judges whether or not there is an invalidated record among the records corresponding to lines whose link flag is set to “UP” and whose line control state flag is set to “NOT CONTROLLED” in the line state table (step S73). Unless there is such an invalidated record (step S73: NO route), the processing progresses to a processing of step S77 described later. On the other hand, if there is such an invalided record (step S73: YES route), the routing table controller 16 validates the pertinent record in the routing table (step S75). Then, the routing table controller 15 judges whether or not there is a change in the routing table (step S77). If there is a change (step S77: YES route), the routing table controller 16 notifies the connected SONET/SDH apparatus 1 of the routing table (step S79). In addition, the routing table controller transmits a packet for a routing update to the relevant router (step S81). On the other hand, unless there is a change in the routing table, the routing control processing is terminated and the processing returns to the original processing (step S77: NO route).

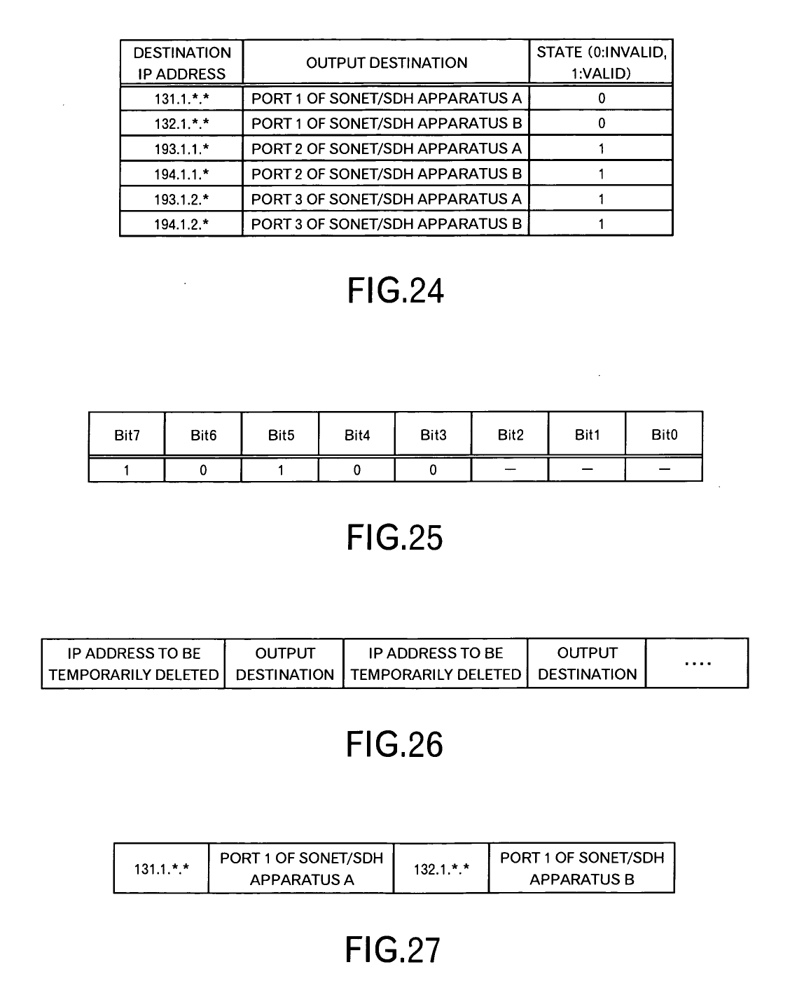

In this embodiment, the port 1 of the SONET/SDH apparatus A and the port 1 of the SONET/SDH apparatus B are set to “CONTROLLED” in the line state table shown in FIG. 21. Therefore, the routing table is updated as shown in FIG. 24. The path overhead processor 18 of the SONET/SDH apparatus A notifies the SONET/SDH apparatus B of an IP address to be temporarily deleted based on the routing table shown in FIG. 24. At this time, the F2 byte is set as shown in FIG. 25: the bit 7 (namely, the routing information) and the bit 5 (namely, the temporary delete of the IP address) are set to 1. Moreover, FIG. 26 shows an example of the format of the payload generated when the IP address to be temporarily deleted is notified. In the example shown in FIG. 26, the combinations of the IP address to be temporarily deleted and the output destination are set by the number of invalidated records. Because two records for the port 1 of the SONET/SDH apparatus A and the port 1 of the SONET/SDH apparatus B are invalidated in the routing table shown in FIG. 24, the payload is set as shown in FIG. 27. Thereafter, the routing table controller 16 of the SONET/SDH apparatus A transmits a packet for a routing update to the router A based on the routing table.

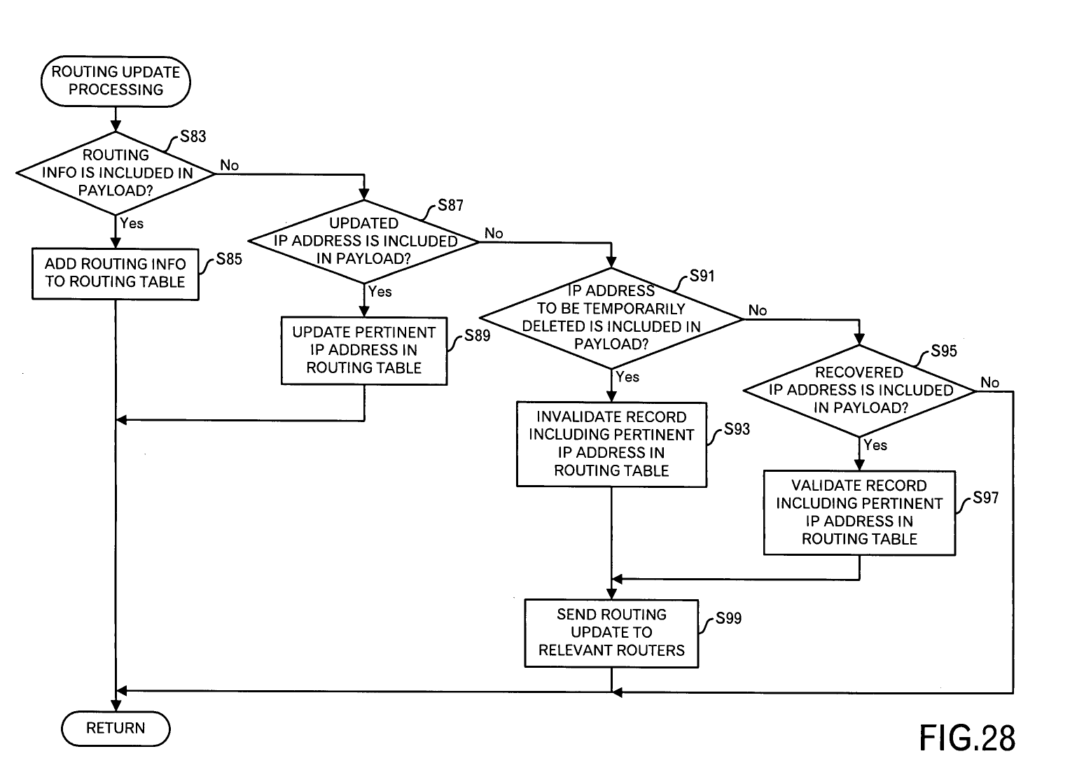

Returning to the description of FIG. 19, the path overhead processor 18 of the SONET/SDH apparatus B receives the IP address to be temporarily deleted (step S35) and carries out a routing table update processing (step S37). The routing table update processing will be described with reference to FIG. 28. The path overhead processor 18 analyzes the received F2 byte. If the payload contains routing information (step S83: YES route), the path overhead processor 18 adds the routing information to the routing table (step S85) and the processing returns to the original processing. On the other hand, unless the payload contains routing information (step S83: NO route), the path overhead processor 18 judges whether or not the payload contains an updated IP address (step S87). If the payload contains the updated IP address (step S87: YES route), the path overhead processor 18 updates the relevant IP address in the routing table (step S89) and the processing returns to the original processing. On the other hand, unless the payload contains the updated IP address (step S87: NO route), the path overhead processor 18 judges whether or not the payload contains an IP address to be temporarily deleted (step S91). If it contains the IP address to be temporarily deleted (step S91: YES route), the path overhead processor 18 invalidates the record including the relevant IP address in the routing table (step S93). On the other hand, unless the payload contains the IP address to be temporarily deleted (step S91: NO route), the path overhead processor 18 judges whether the payload contains a recovered IP address (step S95). If it contains the recovered IP address (step S95: YES route), the path overhead processor 18 validates the record including the relevant IP address in the routing table (step S97). On the other hand, unless the payload contains the recovered IP address, the path overhead processor 18 terminates the routing table update processing and the processing returns to the original processing (step S95: NO route). If the IP address to be temporarily deleted or the recovered IP address is received, the routing table controller 16 transmits a packet for a routing update to the relevant routers based on the routing table (step S99) and the processing returns to the original processing.

In this embodiment, the SONET/SDH apparatus B receives the IP address to be temporarily deleted and updates the routing table. Specifically, the routing table in the SONET/SDH apparatus B also becomes the content as shown in FIG. 24. In addition, the routing table controller 16 of the SONET/SDH apparatus B transmits a packet for a routing update to the router A′ based on the routing table.

Returning to the description of FIG. 19, the SONET/SDH apparatus A and the SONET/SDH apparatus B, which have transmitted the packet for the routing update, start discarding a packet including a routing protocol, which was transmitted from the router (steps S39 and S41). The transfer processors 17 of the SONET/SDH apparatus A and the SONET/SDH apparatus B discard the packet including the routing protocol, which was received from the port of the invalidated record, with reference to the routing table.

After receiving the packet for the routing update, the router A halts the packet transmission to the SONET/SDH apparatus A, and the router A′ halts the packet transmission to the SONET/SDH apparatus B. Moreover, if there is another transmission path, the router A and the router A′ each change the path (steps S43 and S45). Incidentally, data communications between the router B and the router B′ and between the router C and the router C′ are continued.

This enables each SONET/SDH apparatus to keep track of the line to be controlled, thereby enabling a control such as prompting the router using the line to be controlled as a transmission path to switch to another transmission path (for example, via the IP network).

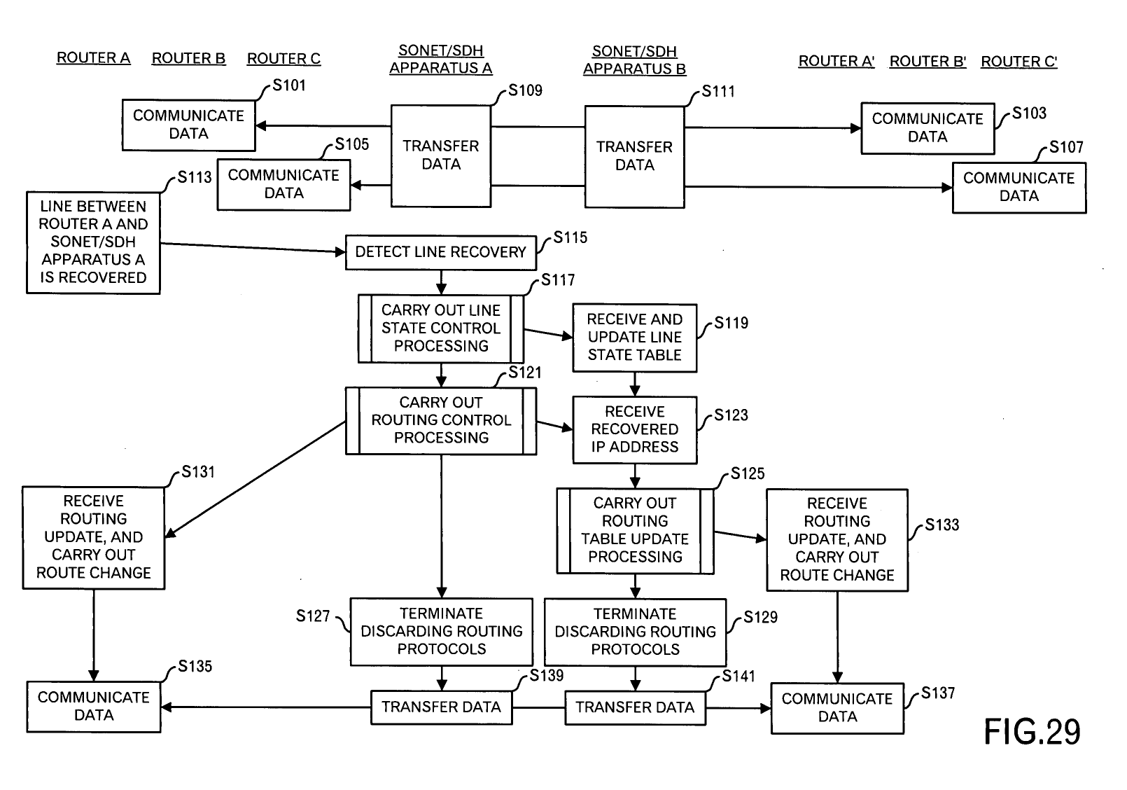

Next, a processing carried out when a line fault occurred between the router A and the SONET/SDH apparatus A recovers in the network configuration shown in FIG. 3 will be described with reference to FIGS. 29 to 32. FIG. 29 shows a processing flow of the entire network. It is assumed that the processing flow in FIG. 29 is continued from the processing flow in FIG. 19. First, data communications are being conducted via the SONET/SDH apparatus A and the SONET/SDH apparatus B between the router B and the router B′ and between the router C and the router C′ (steps S101, S103, S105, and S107). During the data communications, the transfer processors 17 of the SONET/SDH apparatus A and the SONET/SDH apparatus B transfer data to the respective routers (steps S109 to S111). It is assumed that the data communication is being conducted over another transmission path between the router A and the router A′.

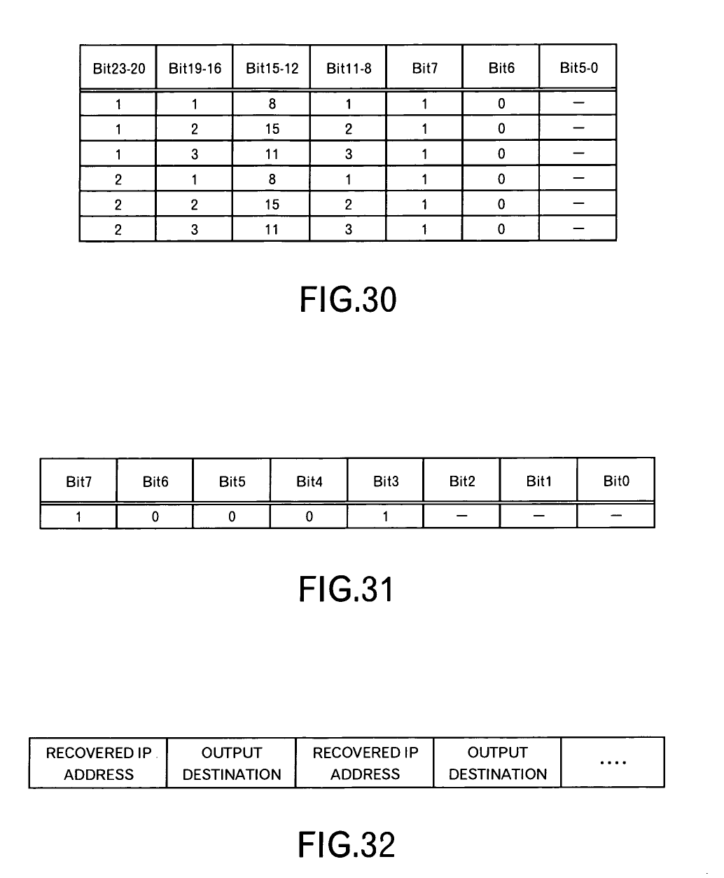

In addition, it is assumed that the line between the router A and the SONET/SDH apparatus A recovered from the line fault (step S113) The error monitor processor 14 of the SONET/SDH apparatus A detects the line recovery by confirming the fulfillment of a predetermined condition (step S115). The error monitor processor 14 notifies the line state controller 15 of recovery information. As described above, the recovery information includes the recovery port number relating to the detected line recovery, and the like. Upon receiving the recovery information, the line state controller 15 carries out the line state control processing (step S117). The processing flow of the line state control processing is the same as one in FIG. 20 described above, and therefore the description is omitted here. The line state controller 15 sets the line control state flag for the port 1 of the SONET/SDH apparatus A and that for the port 1 of the SONET/SDH apparatus B in the line state table to “NOT CONTROLLED.” The line state table in the SONET/SDH apparatus A becomes the content as shown in FIG. 12. Thereafter, the path overhead processor 18 of the SONET/SDH apparatus A notifies the SONET/SDH apparatus B of the line state table. At this time, the F2 byte is set as shown in FIG. 8 and the payload is set as shown in FIG. 30.

The path overhead processor 18 of the SONET/SDH apparatus B receives the line state table and updates its own line state table based on the received information on the line state table (step S119). The line state table in the SONET/SDH apparatus B also achieves the content as shown in FIG. 12.

Subsequently, the routing table controller 16 of the SONET/SDH apparatus A carries out the routing control processing (step S121). The routing control processing flow is the same as one in FIG. 23 described above, and therefore the description is omitted here. The routing table controller 16 validates a record including the port 1 of the SONET/SDH apparatus A and a record including the port 1 of the SONET/SDH apparatus B based on the line state table. The routing table in the SONET/SDH apparatus A becomes the content as shown in FIG. 18. Thereafter, the path overhead processor 18 of the SONET/SDH apparatus A notifies the SONET/SDH apparatus B of the recovered IP address based on the routing table. At this time, the F2 byte is set as shown in FIG. 31: the bit 7 (namely, the routing information) and the bit 3 (namely, the recovery of the IP address) are set to 1. FIG. 32 shows an example of the format of a payload generated when the recovered IP address is notified. In the example shown in FIG. 32, the combinations of the recovered IP address and the output destination are set by the number of validated records. Therefore, a record including the port 1 of the SONET/SDH apparatus A and a record including the port 1 of the SONET/SDH apparatus B are validated, and thereby the payload is set as shown in FIG. 27. Then, the routing table controller 16 of the SONET/SDH apparatus A transmits a packet for a routing update to the router A based on the routing table.

The path overhead processor 18 of the SONET/SDH apparatus B receives the recovered IP address (step S123) and carries out the routing table update processing (step S125). The flow of the routing table update processing is the same as one in FIG. 28 described above, and therefore the description is omitted here. The path overhead processor 18 updates the routing table based on the received recovered IP address. The routing table in the SONET/SDH apparatus B also achieves the content as shown in FIG. 18. The routing table controller 16 of the SONET/SDH apparatus B transmits a packet for a routing update to the router A′ based on the routing table.

The SONET/SDH apparatus A and the SONET/SDH apparatus B, which have transmitted the packet for the routing update, terminate discarding the packet including the routing protocol, which is transmitted from the router (steps S127 and S129).

Upon receiving the packet for the routing update, the router A and the router A′ each change the path to select the transmission path via the SONET/SDH apparatus A or the SONET/SDH apparatus B (steps S131 and S133). This causes the SONET/SDH apparatus A and the SONET/SDH apparatus B to transfer data in the data communication (steps S135 and S137) between the router A and the router A′ (steps S139 and S141). Incidentally, the path change is not necessarily carried out if the router A and the router A′ are communicating with each other over another transmission path.

This enables each SONET/SDH apparatus to keep track of the line to be controlled, thereby enabling a control such as prompting the router connected to the line to be controlled to switch to the transmission path via the SONET/SDH apparatus.

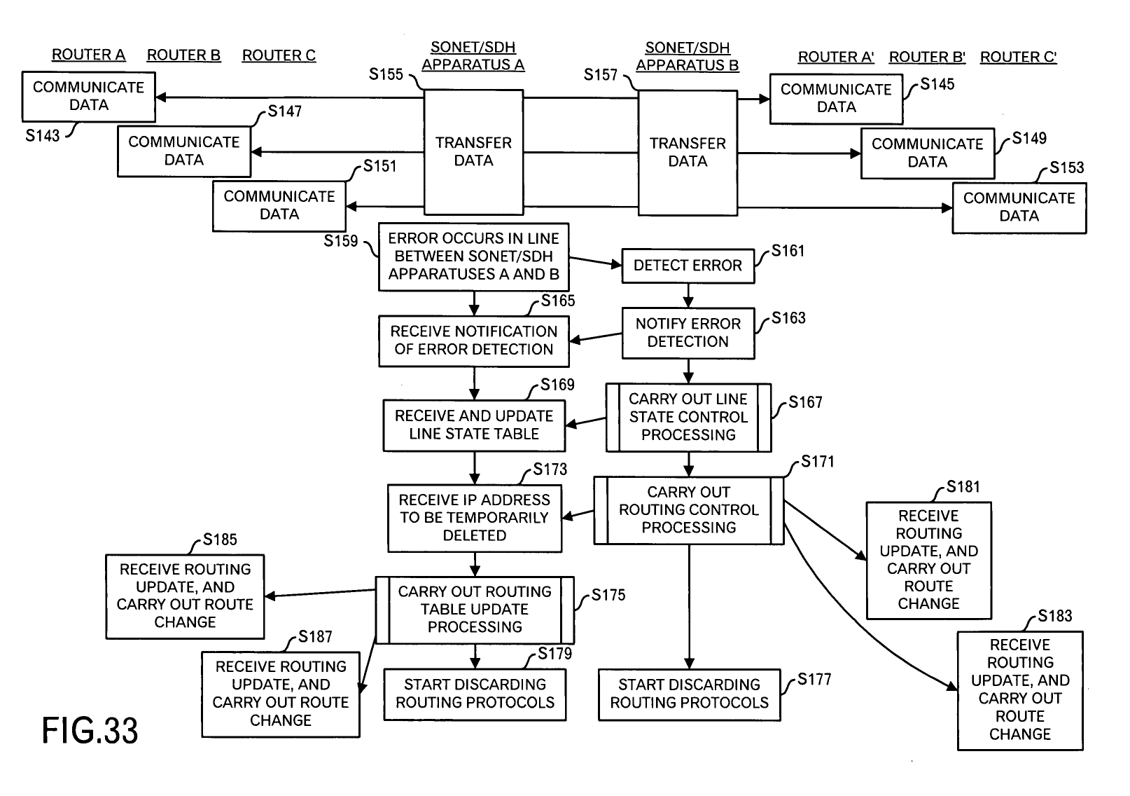

A processing carried out when a line fault occurred between the SONET/SDH apparatus A and the SONET/SDH apparatus B in the network configuration shown in FIG. 3 will be described with reference to FIGS. 33 to 38. FIG. 33 shows a processing flow of the entire network. First, data communications are being conducted via the SONET/SDH apparatus A and the SONET/SDH apparatus B between the router A and the router A′, between the router B and the router B′, and between the router C and the router C′ (steps S143, S145, S147, S149, S151, and S153). During the data communications, the transfer processors 17 of the SONET/SDH apparatus A and the SONET/SDH apparatus B transfer data to the respective routers (steps S155 and S157).

In this embodiment, it is assumed that line quality deterioration of a 10⁻¹⁰-level error rate occurred on the line between the SONET/SDH apparatus A and the SONET/SDH apparatus B, for example, due to a trouble in optical fibers (step S159). The error monitor processor 14 of the SONET/SDH apparatus B detects the error from a K1 byte and a K2 byte in the SONET/SDH frame (step S161). First, the error monitor processor 14 of the SONET/SDH apparatus B notifies the SONET/SDH apparatus A of the error detection by using the K1 byte and the K2 byte in the SONET/SDH frame (step S163). The error monitor processor 14 of the SONET/SDH apparatus A receives the notification of the error detection from the SONET/SDH apparatus B (step S165).

Subsequently, the error monitor processor 14 of the SONET/SDH apparatus B notifies the line state controller 15 of the error information. At this time, the error information contains information indicating that the line fault is detected between the SONET/SDH apparatuses. Upon receiving the error information, the line state controller 15 carries out the line state control processing (step S167).

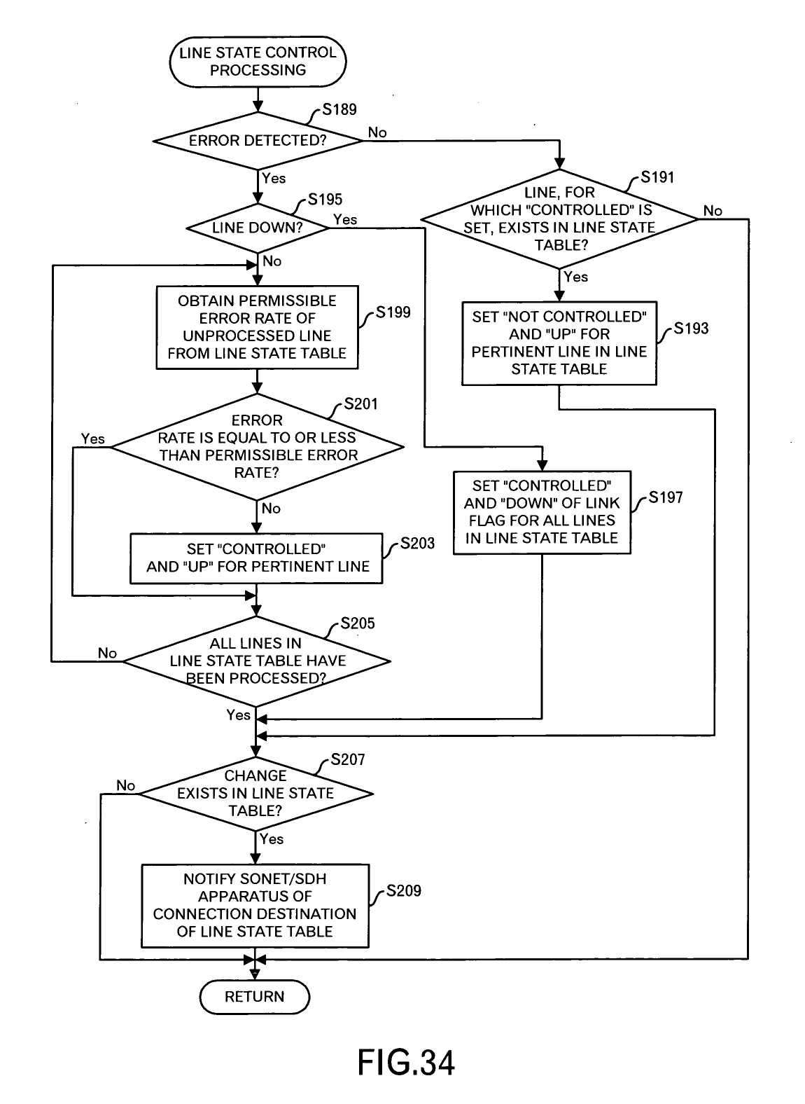

The line state control processing carried out when the line fault was detected between the SONET/SDH apparatuses will be described with reference to FIG. 34. First, the line state controller 15 judges whether or not the line fault is detected (step S189). If the line recovery is detected instead of a line fault (step S189: NO route), the line state controller 15 judges whether or not there is a line whose line control state flag is set to “CONTROLLED” in the line state table (step S191). If there is a line whose line control state flag is set to “CONTROLLED” (step S191: YES route), the line state controller 15 sets the line control state flag to “NOT CONTROLLED” and the link flag to “UP” for the line (step S193). Thereafter, the processing progresses to a processing in step S207 described later. If the link flag of the line is set to “UP,” the setting is directly used. On the other hand, if there is no line whose line control state flag is set to “CONTROLLED,” the line state control processing is terminated and the processing returns to the original processing (step S191: NO route).

On the other hand, if a line fault is detected (step S189: YES route), the line state controller 15 judges whether or not the link is disconnected, based on the link information (step S195). If the link is disconnected (step S195: YES route), the line state controller 15 sets the line control state flag to “CONTROLLED” and the link flag to “DOWN” for all lines in the line state table (step S197). Thereafter, the processing progresses to a processing in step S207 described later. On the other hand, if line quality deterioration occurs instead of the link disconnection (step S195: NO route), the line state controller 15 obtains a permissible error rate of an unprocessed line from the line state table (step S199). Then, the line state controller 15 compares the error rate in the error information with the obtained permissible error rate (step S201). If the error rate is equal to or less than the permissible error rate (step S201: YES route), the processing progresses to a processing in step S205 described later. On the other hand, if the error rate exceeds the permissible error rate (step S201: NO route), the line state controller 15 sets the line control state flag to “CONTROLLED” and the link flag to “UP” (step S203) for the line being processed in the line state table. Subsequently, the line state controller 15 judges whether the processing is completed for all lines in the line state table (step S205). If there is an unprocessed line (step S205: NO route), the processing returns to the processing of the step S199. On the other hand, if the processing is completed for all lines in the line state table (step S205: YES route), the line state controller 15 judges whether or not there is a change in the line state table (step S207). If there is no change in the line state table, the line state control processing is terminated and the processing returns to the original processing (step S207: NO route). On the other hand, if there is a change in the line state table (step S207: YES route), the line state controller 15 notifies the connected SONET/SDH apparatus 1 of the line state table (step S209) and the processing returns to the original processing.

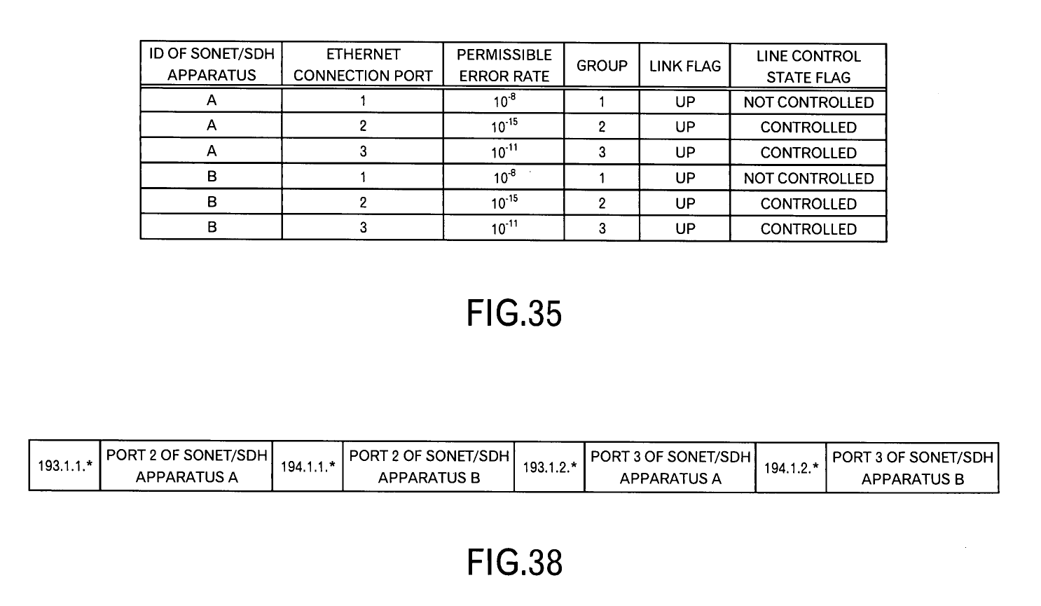

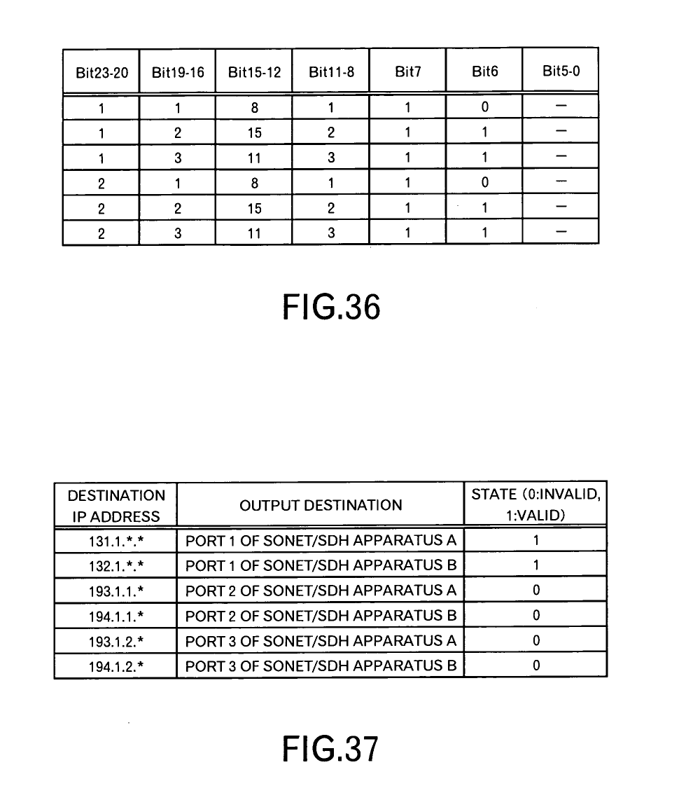

In this embodiment, the permissible error rates of the port 1, the port 2, and the port 3 of the SONET/SDH apparatus B are 10⁻⁸, 10⁻¹⁵, and 10⁻¹¹, respectively, as shown in FIG. 12. Because an error of a 10⁻¹⁰-level error rate occurred, it exceeds the permissible error rate for the port 2 and the port 3. Therefore, the lines connected to the port 2 and the port 3 are determined to be lines to be controlled. In the line state table, the line state control flags of the port 2 and the port 3 are set to “CONTROLLED” as shown in FIG. 35. At this time, the port 2 and the port 3 of the SONET/SDH apparatus B belong to the group 2 and the group 3, respectively. Therefore, the line control state flags of the port 2 belonging to the group 2 at the SONET/SDH apparatus A side and the port 3 belonging to the group 3 at the SONET/SDH apparatus A are also set to “CONTROLLED.” Thereafter, the path overhead processor 18 of the SONET/SDH apparatus B notifies the SONET/SDH apparatus A of the line state table shown in FIG. 35. At this moment, the F2 byte shown in FIG. 8 and the payload shown in FIG. 36 are set in the SONET/SDH frame.

Returning to the description of FIG. 33, the path overhead processor 18 of the SONET/SDH apparatus A receives the line state table and updates its own line state table based on the received information on the line state table (step S169). Specifically, the line state table in the SONET/SDH apparatus A also achieves the content as shown in FIG. 35.

Subsequently, the routing table controller 16 of the SONET/SDH apparatus B carries out the routing control processing (step S171). The routing control processing flow is the same as one in FIG. 23 described above, and therefore the description is omitted here. The routing table controller 16 invalidates records including the port 2 and the port 3 of the SONET/SDH apparatus A and the port 2 and the port 3 of the SONET/SDH apparatus B on the basis of the line state table. The routing table in the SONET/SDH apparatus B is updated as shown in FIG. 37. Thereafter, the path overhead processor 18 of the SONET/SDH apparatus B notifies the SONET/SDH apparatus A of the IP address to be temporarily deleted based on the routing table shown in FIG. 37. At this time, the F2 byte shown in FIG. 25 and the payload shown in FIG. 38 are set in the SONET/SDH frame. Four ports are set in FIG. 38: the port 2 and the port 3 of the SONET/SDH apparatus A and the port 2 and the port 3 of the SONET/SDH apparatus B. Thereafter, the routing table controller 16 of the SONET/SDH apparatus B transmits a packet for a routing update to the router B′ and the router C′ based on the routing table.

The path overhead processor 18 of the SONET/SDH apparatus A receives the IP address to be temporarily deleted (step S173) and carries out the routing table update processing (step S175). The routing table update processing flow is the same as one in FIG. 28 described above, and therefore the description is omitted here. The path overhead processor 18 updates the routing table based on the received IP address to be temporarily deleted. The routing table in the SONET/SDH apparatus A achieves the content as shown in FIG. 37. Then, the routing table controller 16 of the SONET/SDH apparatus A transmits a packet for a routing update to the router B and the router C based on the routing table.

The SONET/SDH apparatus A and the SONET/SDH apparatus B, which have transmitted the packet for the routing update, starts discarding packets including the routing protocol transmitted from the routers (steps S177 and S179). The transfer processors 17 of the SONET/SDH apparatus A and the SONET/SDH apparatus B discard the packets including the routing protocol, which are received from ports for the invalidated records with reference to the routing table.

After receiving the packet for the routing update, the router B and the router C halt the packet transmission to the SONET/SDH apparatus A, and the router B′ and the router C′ halt the packet transmission to the SONET/SDH apparatus B. The router B, the router B′, the router C, and the router C′ each change the path if there is another transmission path (steps S181, S183, S185, and S187). Incidentally, the data communication between the router A and the router A′ is continued without change.

Thus, a line to be controlled can be identified from among all lines connected to the SONET/SDH apparatus according to a required line quality (for example, a permissible error rate), whereby only routers affecting the line quality can be controlled.

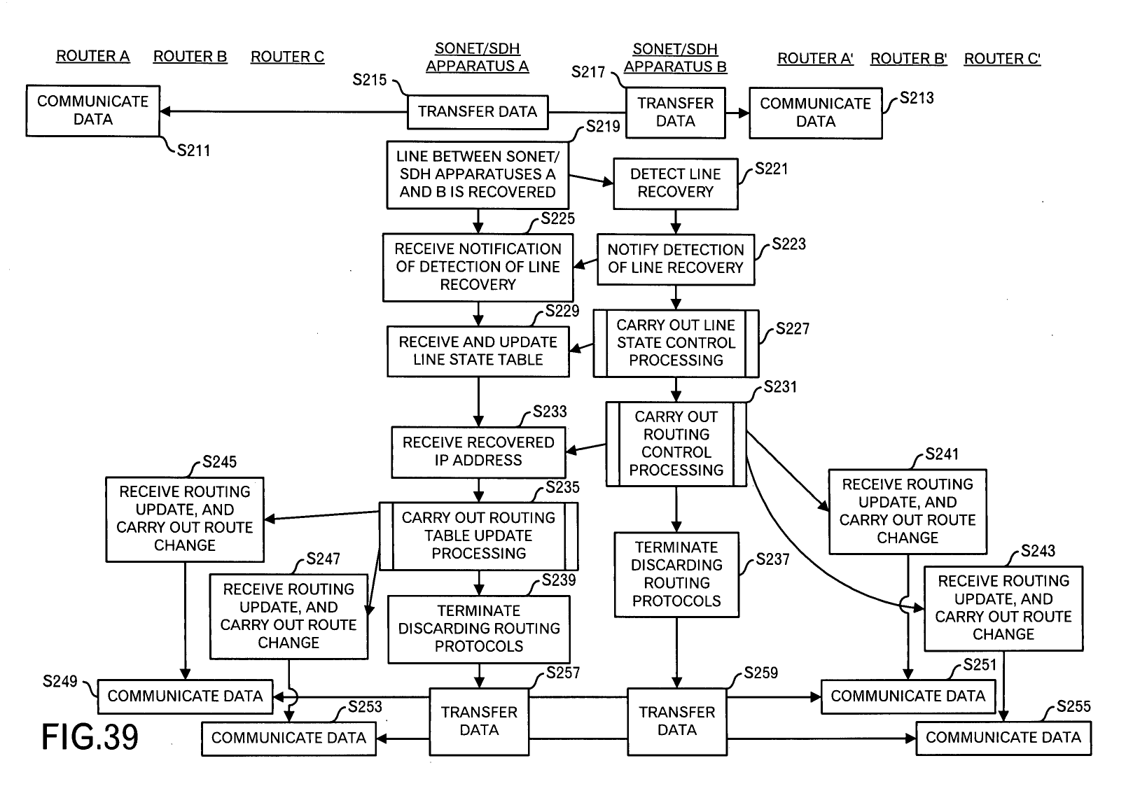

Next, a processing carried out when a line between the SONET/SDH apparatus A and the SONET/SDH apparatus B recovered from an error in the network configuration shown in FIG. 3 will be described with reference to FIG. 39. FIG. 39 shows a processing flow in the entire network. Incidentally, it is assumed that the processing flow in FIG. 39 is carried out after the processing flow in FIG. 33. First, data communication is being conducted via the SONET/SDH apparatus A and the SONET/SDH apparatus B between the router A and the router A′ (steps S211 and S213). The transfer processors 17 of the SONET/SDH apparatus A and the SONET/SDH apparatus B transfer data to the respective routers (steps S215 and S217). It is assumed that data communications are being conducted over other transmission paths between the router B and the router B′ and between the router C and the router C′.

Then, it is assumed that the line between the SONET/SDH apparatus A and the SONET/SDH apparatus B recovered from the line fault (step S219). The error monitor processor 14 of the SONET/SDH apparatus B detects the line recovery from the K1 byte and the K2 byte in the SONET/SDH frame (step S221). Then, the error monitor processor 14 of the SONET/SDH apparatus B notifies the SONET/SDH apparatus A of the detection of the line recovery by using the K1 byte and the K2 byte in the SONET/SDH frame (step S223). The error monitor processor 14 of the SONET/SDH apparatus A receives the detection notification of the line recovery from the SONET/SDH apparatus B (step S225).

Subsequently, the error monitor processor 14 of the SONET/SDH apparatus B notifies the line state controller 15 of the recovery information. At this time, the recovery information contains information indicating that the line recovery is detected between the SONET/SDH apparatuses. Upon receiving the recovery information, the line state controller 15 carries out the line state control processing (step S227). The line state control processing flow is the same as one in FIG. 34 described above, and therefore the description is omitted here. The line state controller 15 sets the line control state flags of the port 2 and the port 3 of the SONET/SDH apparatus A and the port 2 and the port 3 of the SONET/SDH apparatus B to “NOT CONTROLLED.” The line state table in the SONET/SDH apparatus B achieves the content as shown in FIG. 12. The path overhead processor 18 of the SONET/SDH apparatus B notifies the SONET/SDH apparatus A of the line state table. Then, the F2 byte is set as shown in FIG. 8 and the payload is set as shown in FIG. 30.

The path overhead processor 18 of the SONET/SDH apparatus A receives the line state table and updates its own line state table based on the received information on the line state table (step S229). The line state table in the SONET/SDH apparatus A also achieves the content as shown in FIG. 12.

Subsequently, the routing table controller 16 of the SONET/SDH apparatus B performs routing control processing (step S231). The routing control processing flow is the same as one in FIG. 23 described above, and therefore the description is omitted here. The routing table controller 16 validates records including the port 2 and the port 3 of the SONET/SDH apparatus A and the port 2 and the port 3 of the SONET/SDH apparatus B on the basis of the line state table. The routing table in the SONET/SDH apparatus B achieves the content as shown in FIG. 18. Thereafter, the path overhead processor 18 of the SONET/SDH apparatus B notifies the SONET/SDH apparatus A of the recovered IP address based on the routing table. At this moment, the F2 byte shown in FIG. 31 and the payload shown in FIG. 38 are set in the SONET/SDH frame. Thereafter, the routing table controller 16 of the SONET/SDH apparatus B transmits a packet for a routing update to the router B′ and the router C′ based on the routing table.

The path overhead processor 18 of the SONET/SDH apparatus A receives the recovered IP address (step S233) and carries out the routing table update processing (step S235). The routing table update processing flow is the same as one in FIG. 28 described above, and therefore the description is omitted here. The path overhead processor 18 updates the routing table based on the received recovered IP address. The routing table in the SONET/SDH apparatus A also achieves the content as shown in FIG. 18. Thereafter, the routing table controller 16 of the SONET/SDH apparatus A transmits a packet for a routing update to the router B and the router C based on the routing table.

The SONET/SDH apparatus A and the SONET/SDH apparatus B, which have transmitted the packet for the routing update, terminate discarding the packets including the routing protocol, which are transmitted from the routers (steps S237 and S239).

Upon receiving the packet for the routing update, the router B, the router B′, the router C, and the router C′ change the paths to select the transmission path via the SONET/SDH apparatus A and the SONET/SDH apparatus B, respectively (steps S241, S243, S245, and S247) This causes the SONET/SDH apparatus A and the SONET/SDH apparatus B to transfer data (steps S257 and S259) in the data communications between the router B and the router B′ and between the router C and the router C′ (steps S249, S251, S253, and S255). Incidentally, the path change is not necessarily carried out if the data communications are being conducted over other transmission paths between the router B and the router B′ and between the router C and the router C′.

This enables each SONET/SDH apparatus to keep track of the line to be controlled, thereby enabling a control such as prompting the router connected to the line to be controlled to switch to the transmission path via the SONET/SDH apparatus.

While the processing carried out at recovery from the line fault has been described with reference to FIG. 39, a processing carried out when a line quality gradually recovers from deterioration in quality instead of full recovery from a line fault. For example, it is assumed that the line quality recovered from 10⁻¹⁰ to 10⁻¹³ in the error rate in the step S219 of the processing flow shown in FIG. 39. The error monitor processor 14 of the SONET/SDH apparatus B detects the error rate recovery and notifies the line state controller 15 of the recovery information including the error rate (namely, 10⁻¹³). Thereafter, the line state controller 15 carries out the line state control processing shown in FIG. 34. In this case, however, it compares the permissible error rate of the port whose line control state flag is set to “CONTROLLED” with the error rate included in the recovery information before the processing in the step S193. If the error rate becomes equal to or less than the permissible error rate, the processing progresses to the processing in the step S193. On the other hand, if the error rate still exceeds the permissible error rate, the processing in the step S193 is not carried out. In the above example, the permissible error rate of the port 2 is 10⁻¹⁵ and that of the port 3 is 10⁻¹¹. Therefore, the line control state flag of the port 2 is maintained at “CONTROLLED” and the line control state flag of the port 3 is set to “NOT CONTROLLED.” The subsequent processing is the same as the processing described in FIG. 39, and therefore the description is omitted here.

In addition, a processing carried out when a line recovery is detected, for example, on a SONET/SDH line in a situation where line faults occur on both the SONET/SDH line and the Ethernet™ line will be described. Although not shown, it is assumed that two line control state flags are prepared in the line state table: one is a line control state flag for the Ethernet™ line (hereinafter, referred to as “Ethernet™ flag”) and the other is a line control state flag for the SONET/SDH line (hereinafter, referred to as “SONET/SDH flag”). Other portions of the line state table are assumed to be the same as those in the line state table shown in FIG. 12. In this embodiment, it is assumed that the line between the router A and the SONET/SDH apparatus A deteriorates in quality at a 10⁻⁷-level error rate and that the line between the SONET/SDH apparatus A and the SONET/SDH apparatus B deteriorates in quality at a 10⁻¹⁰-level error rate in the network configuration shown in FIG. 3. In the line state table in this situation, the Ethernet™ flags of the port 1 of the SONET/SDH apparatus A and the port 1 of the SONET/SDH apparatus B are set to “CONTROLLED,” the SONET/SDH flags of the port 2 and port 3 of the SONET/SDH apparatus A and the SONET/SDH flags of the port 2 and port 3 of the SONET/SDH apparatus B are set to “CONTROLLED,” and other flags are set to “NOT CONTROLLED.” Thereafter, it is supposed that the line recovery is detected on the SONET/SDH line. The processing carried out when the line recovery is detected is basically the same as one in FIG. 39. Note that, however, only the SONET/SDH flags are processed here because there are two types of line control state flags in the line state table. Therefore, the Ethernet™ flag of the port 1 of the SONET/SDH apparatus A and the Ethernet™ flag of the port 1 of the SONET/SDH apparatus B are maintained at “CONTROLLED,” and the SONET/SDH flags of the port 2 and port 3 of the SONET/SDH apparatus A and the SONET/SDH flags of the port 2 and port 3 of the SONET/SDH apparatus B are updated to “NOT CONTROLLED.” Therefore, a packet for a routing update is transmitted to the router B, the router C, the router B′, and the router C′.

As described hereinabove, according to the embodiment, it is possible to change a transmission path to another according to a required line quality in the case of deterioration in quality of the SONET/SDH line, thereby achieving a stable network operation. Moreover, even if a line fault occurs on the Ethernet™ line, a communication control can be carried out for each connected router by achieving synchronization of the routing table between the SONET/SDH apparatuses.

While the embodiment of the present invention has been described hereinabove, it is to be understood that the subject matter encompassed by the present invention is not limited to the specific embodiment. For example, the system is not limited to the SONET/SDH apparatus, but the present invention is also applicable to a wavelength division multiplexing (WDM) system. Moreover, the functional block diagram shown in FIG. 2 is illustrative only, and it does not always conform to an actual module configuration.

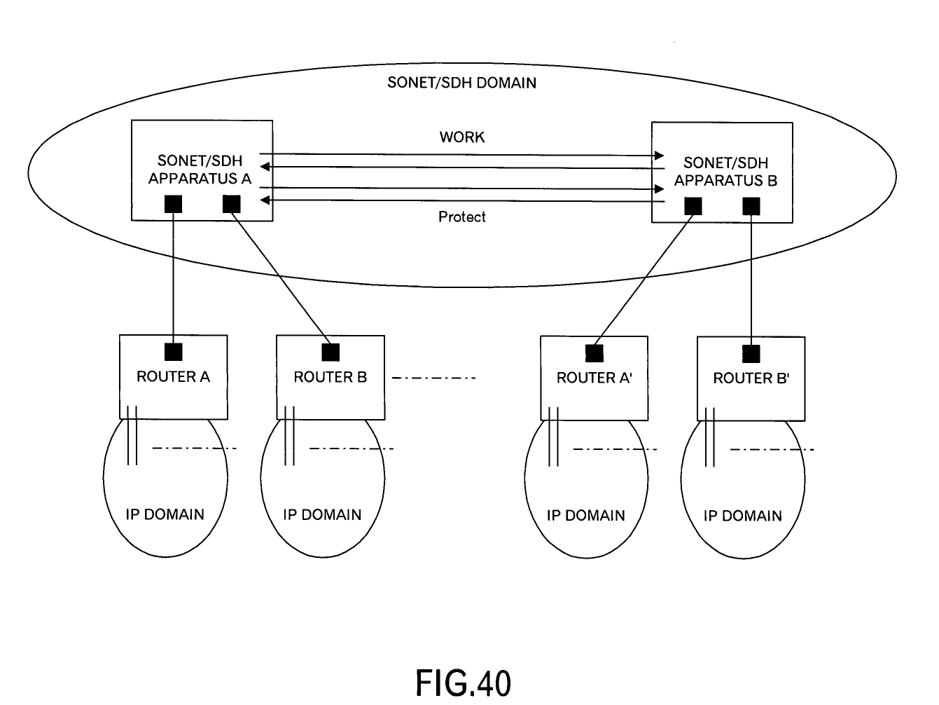

Furthermore, while the SONET/SDH network without a redundant configuration has been used as shown in FIG. 3, the SONET/SDH network may include a redundant configuration as shown in FIG. 40. In FIG. 40, “WORK” denotes the normal line and “Protect” denotes a redundant line. For example, if a line fault occurs on both the normal line and the redundant line, the communication can be appropriately controlled by carrying out the above processing.

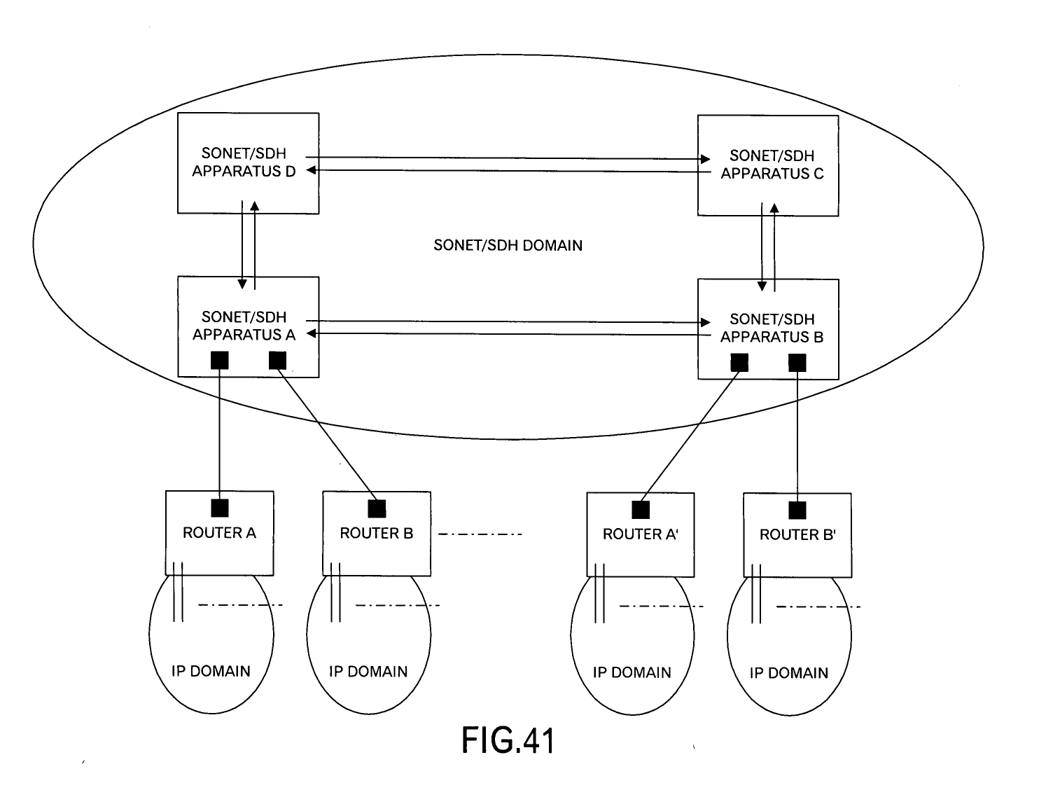

In addition, the SONET/SDH network may have a ring configuration as shown in FIG. 41. In FIG. 41, the SONET/SDH network is composed of a SONET/SDH apparatus A, a SONET/SDH apparatus B, a SONET/SDH apparatus C, and a SONET/SDH apparatus D. For example, if a line fault occurs between the SONET/SDH apparatus A and the SONET/SDH apparatus B, it is possible to select a transmission path via the IP network by carrying out the above processing, though the data communication can be continued via the SONET/SDH apparatus D and the SONET/SDH apparatus C.

Moreover, a line fault may be detected in some cases independently of the line quality. In this case, the line to be controlled is identified without reference to the required line quality.

What is claimed is:

1. A transmission apparatus, comprising:
a line database that stores required line quality data for each first line connecting between said transmission apparatus and a router;
a fault detector that detects a line fault in said first lines or a second line connecting between said transmission apparatus and another transmission apparatus; and
a control target identifying unit that identifies a line to be controlled from said first lines based on information of said line fault or said information of said line fault and said required line quality data, upon detection of said line fault by said fault detector.

2. The transmission apparatus as set forth in claim 1, further comprising:
a unit that generates a record including a destination address and identification information of an output destination port corresponding to said destination address, and registers the generated record in a routing table; and
a unit that invalidates a record in which identification information of a connection port connected to the identified line to be controlled is registered as said identification information of said output destination port in said routing table.

3. The transmission apparatus as set forth in claim 2, further comprising:
a recovery detector that detects a line recovery in said identified line to be controlled; and
a unit that validates said record in which said identification information of said connection port connected to said identified line to be controlled, for which said line recovery was detected, is registered as said identification information of said output destination port in said routing table in response to detection of said line recovery by said recovery detector.

4. The transmission apparatus as set forth in claim 1, wherein said line database further stores identification data to identify whether or not said first line is said line to be controlled, and
said transmission apparatus further comprises:
a unit that updates said identification data, upon detecting change of said line to be controlled; and
a unit that outputs information concerning at least a changed portion of said line database to said another transmission apparatus, upon detecting change of said line database.

5. The transmission apparatus as set forth in claim 1, further comprising:
a unit that updates said line database based on received information concerning said line database, upon receiving said information concerning said line database from said another transmission apparatus.

6. The transmission apparatus as set forth in claim 2, further comprising:
a unit that outputs data of an added or changed record to said another transmission apparatus, upon detecting addition or change of a record in said routing table.

7. The transmission apparatus as set forth in claim 2, further comprising:
a unit that updates said routing table based on received data concerning a record in said routing table, upon receiving said data concerning said record in said routing table from said another transmission apparatus.

8. The transmission apparatus as set forth in claim 2, further comprising:
a unit that generates a control packet causing to reflect change of said routing table upon detecting said change of said routing table, and outputs the generated control packet to a router connected to the identified line to be controlled.

9. A transmission apparatus, comprising:
a unit that generates a record including a destination address and identification information of an output destination port corresponding to said destination address, and registers the generated record in a routing table;
a fault detector that detects a line fault in first lines connecting between said transmission apparatus and routers or a second line connecting between said transmission apparatus and another transmission apparatus;
a control target identifying unit that identifies a line to be controlled from said first lines based on information concerning said line fault, upon detection of said line fault by said fault detector; and
a unit that invalidates a record in which identification information of a connection port connected to the identified line to be controlled is registered as said identification information of said output destination port in said routing table.

10. The transmission apparatus as set forth in claim 9, further comprising:
a line database storing required line quality data for each said first line, and
wherein said control target identifying unit comprises:
a unit that identifies a line to be controlled from said first lines based on said information of said line fault and said required line quality data, upon detection of said line fault in said second line by said fault detector.

11. A communication control method, comprising:
detecting a line fault in first lines connecting between a transmission apparatus and routers or a second line connecting between said transmission apparatus and another transmission apparatus; and
upon detection of said line fault in said detecting, identifying a line to be controlled from said first lines based on information of said line fault or said information of said line fault and required line quality data stored in a line database storing said required line quality data for each said fist line.

12. A communication control method, comprising:
generating a record including a destination address and identification information of an output destination port corresponding to said destination address, and registering the generated record in a routing table;
detecting a line fault in first lines connecting between a transmission apparatus and routers or a second line connecting between said transmission apparatus and another transmission apparatus;
identifying a line to be controlled from said first lines based on information concerning said line fault, upon detection of said line fault in said detecting; and
invalidating a record in which identification information of a connection port connected to the identified line to be controlled is registered as said identification information of said output destination port in said routing table.
